(19) United States
(12) Patent Application Publication
(10) Pub. No.: US 2020/0294028 A1
(43) Pub. Date: Sep. 17, 2020

(54) PAYMENT SYSTEM AND METHOD USING SHORT-RANGE COMMUNICATION

(71) Applicant: SAMSUNG ELECTRONICS CO., LTD., Suwon-si, Gyeonggi-do (KR)

(72) Inventor: Sang-gun LEE, Suwon-si, Gyeonggi-do (KR)

(21) Appl. No.: 16/074,545

(22) PCT Filed: Aug. 19, 2016
(86) PCT No.: PCT/KR2016/009178

§ 371 Date: Aug. 1, 2018

(30) Foreign Application Priority Data
Feb. 5, 2016 (KR) 10-2016-0015002

(51) Int. Cl. G06Q 20/32; G06Q 20/40; G06Q 20/38

(52) U.S. Cl. CPC G06Q 20/3278; G06Q 20/3829; G06Q 20/4015; G06Q 20/40975

(57) ABSTRACT

Provided is a method, performed by a first device, of purchasing a product, the method including: receiving store identification data broadcast from a second device, when the first device is located within a range of short-range communication with respect to the second device; authenticating the second device by using the store identification data; receiving a user input of determining a product to be purchased, when a user of the second device is authenticated; and broadcasting payment data for purchasing the determined product via the short-range communication.

### TECHNICAL FIELD

The disclosure relates to a payment system and a method using short-range communication.

### BACKGROUND ART

With developments in multimedia technologies and network technologies, devices are connected to each other to perform communication and exchange various information with each other, thereby providing various services to a user. In particular, when devices perform short-range communication, unnecessary information may be accumulated in the devices as the devices are unnecessarily connected to each other for communication. Also, when the devices are unnecessarily connected to each other for communication, an issue of security with respect to information provided from a device to another device may occur.

Thus, a technique by which a device efficiently authenticates another device and effectively provides appropriate information to the other device is required.

### DESCRIPTION OF EMBODIMENTS

### Technical Problem

According to an embodiment, there are provided a method and a system for purchasing a product by using data broadcast between devices. The technical objectives of the disclosure are not limited to the technical problems described above, and other technical objectives may become apparent based on the embodiments hereinafter.

### Solution to Problem

According to an embodiment, a method, performed by a first device, of purchasing a product, includes: receiving store identification data broadcast from a second device, when the first device is located within a range of short-range communication with respect to the second device; authenticating the second device by using the store identification data; receiving a user input of determining a product to be purchased, when a user of the second device is authenticated; and broadcasting payment data for purchasing the determined product via the short-range communication, wherein the broadcast payment data is provided to the second device.

### BRIEF DESCRIPTION OF DRAWINGS

FIG. 1 is a schematic diagram illustrating an example of a payment system using short-range communication, according to embodiments.

FIG. 2 is a flowchart of an operation method of a payment system using short-range communication, according to embodiments.

FIG. 3 is a diagram illustrating an example in which a payment system manages key data of devices via an authentication server, according to embodiments.

FIG. 4 is a flowchart of a method, performed by a first device, of authenticating a second device by using a message broadcast from the second device, according to embodiments.

FIG. 5 is a flowchart of a method, performed by a first device, of authenticating a second device by using a message broadcast from the second device, according to embodiments.

FIG. 6 illustrates an example in which a first device provides information about a store in which a second device is located.

FIGS. 7 and 8 illustrate examples of a graphical user interface (GUI) for receiving a user input of determining a product to be purchased by a first device.

FIG. 9 is a flowchart of a method, performed by a first device, of purchasing a product by broadcasting payment data.

FIG. 10 is a flowchart of a method, performed by a first device, of broadcasting payment data.

FIG. 11 is a flowchart of another method, performed by a first device, of broadcasting payment data.

FIG. 12 is a flowchart of a method, performed by a first device, of providing authentication data of a first device to a payment server in response to a request of the payment server.

FIG. 13 illustrates an example in which a first device provides a GUI for determining paying data of a product to be purchased and a GUI for indicating that the payment for the product is completed.

FIG. 14 illustrates an example in which a payment system manages store data corresponding to a second device, via an authentication server, according to an embodiment.

FIG. 15 illustrates an example in which a first device executes a universal resource locator (URL) obtained from an authentication server.

FIG. 16 illustrates another example in which a first device executes a URL obtained from an authentication server.

FIG. 17 is a flowchart of a method, performed by a first device, of obtaining store data of a second device, according to embodiments.

FIG. 18 illustrates an example in which, when there are a plurality of second devices, a first device authenticates at least one second device, according to embodiments.

FIG. 19 is a flowchart of an operation method of a payment system using short-range communication, according to embodiments.

FIG. 20 is a flowchart of a method, performed by a first device, of broadcasting product data of a determined product.

FIG. 21 illustrates an example in which a second device provides a GUI for receiving, from a user, an input of purchase confirmation information, as product data broadcast by a first device is obtained.

FIG. 22 illustrates a structure of data broadcast by a payment system, according to embodiments.

FIGS. 23 and 24 illustrate a structure of a first device according to embodiments.

FIG. 25 illustrates a structure of a second device according to embodiments.

FIG. 26 illustrates a structure of an authentication server according to embodiments.

### BEST MODE

According to an aspect of the disclosure, there is provided a method, performed by a first device, of purchasing a product, the method including: receiving store identification data broadcast from a second device, when the first device is located within a range of short-range communication with respect to the second device; authenticating the second device by using the store identification data; receiving a user input of determining a product to be purchased, when a user of the second device is authenticated; and broadcasting payment data for purchasing the determined product via the short-range communication, wherein the broadcast payment data is provided to the second device.

The store identification data may be encrypted using a private key of the user of the second device.

The authenticating of the second device may include decrypting the encrypted store identification data by using a public key of the user of the second device, and the public key may be provided to the first device via a payment application installed in the first device.

The public key of the user of the second device may be stored in the first device or an external server.

The payment data may include paying data obtained from a payment server when the user input is received, and the paying data may be temporarily generated by using a random number and a card number of a user of the first device, the card number being registered in the payment server.

The broadcasting of the payment data may include: encrypting product data of the determined product and the payment data by using a public key of the user of the second device; and broadcasting the encrypted product data and the encrypted payment data.

The method may further include obtaining a list of products sold at a store in which the second device is installed, and the determining of the product to be purchased may include determining the product to be purchased based on the obtained list of the products.

The list of the products may be broadcast from the second device.

The first device may communicate with the second device via Bluetooth low energy (BLE).

The store identification data and the payment data may be broadcast between the first device and the second device, and the first device and the second device may not be in connection with each other for communication.

According to another aspect of the disclosure, there is provided a method, performed by a first device, of purchasing a product, the method including: receiving store identification data broadcast from a second device, when the first device is located within a range of short-range communication with respect to the second device; authenticating the second device by using the store identification data; receiving a user input of determining a product to be purchased, when a user of the second device is authenticated; broadcasting product data of the determined product; and transmitting payment data for purchasing the determined product to a payment server, wherein the product data is provided to the second device.

The broadcasting of the product data may include: encrypting the product data by using a public key of the user of the second device; and broadcasting the encrypted product data.

According to another aspect of the disclosure, there is provided a first device including: a communicator configured to receive store identification data broadcast from a second device, when the first device is located within a range of short-range communication with respect to the second device; a controller configured to authenticate the second device by using the store identification data; and an input unit configured to receive a user input of determining a product to be purchased, when a user of the second device is authenticated, wherein the communicator is further configured to broadcast payment data for purchasing the determined product via the short-range communication, and the broadcast payment data is provided to the second device.

The store identification data may be encrypted using a private key of the user of the second device.

The controller may decrypt the encrypted store identification data by using a public key of the user of the second device, and the public key may be provided to the first device via a payment application installed in the first device.

The public key of the user of the second device may be stored in the first device or an external server.

The payment data may include paying data obtained from a payment server when the user input is received, and the paying data may be temporarily generated by using a random number and a card number of a user of the first device, the card number being registered in the payment server.

The controller may encrypt product data of the determined product and the payment data by using a public key of the user of the second device, and the communicator may broadcast the encrypted product data and the encrypted payment data.

The first device may communicate with the second device via BLE.

The store identification data and the payment data may be broadcast between the first device and the second device, and the first device and the second device may not be in connection with each other for communication.

According to another aspect of the disclosure, there is provided a non-transitory computer-readable recording medium having recorded thereon a program for executing the method, performed by the first device, of purchasing the product.

### MODE OF DISCLOSURE

Hereinafter, embodiments of the disclosure will be described in detail with reference to the accompanying drawings to fully convey the concept of the disclosure to one of ordinary skill in the art. The disclosure may, however, be embodied in many different forms and should not be construed as being limited to the embodiments set forth herein. In the drawings, like reference numerals denote like elements. Also, while describing the disclosure, detailed descriptions about related well known functions or configurations that may blur the points of the disclosure are omitted.

The terms used in the disclosure are selected from among common terms that are currently widely used in consideration of their function in the disclosure. However, the terms may be different according to an intention of one of ordinary skill in the art, a precedent, or the advent of new technology. Therefore, the terms used in the disclosure are not merely designations of the terms, but the terms are defined based on the meaning of the terms and content throughout the disclosure.

It will be understood that, although the terms first, second, etc. may be used herein to describe various elements, these elements should not be limited by these terms. These terms are only used to distinguish one element from another.

The terminology used herein is for the purpose of describing particular embodiments only and is not intended to be limiting of example embodiments of the disclosure. As used herein, the singular forms “a”, “an” and “the” are intended to include the plural forms as well, unless the context clearly indicates otherwise. Also, throughout the specification, it will be understood that when an element is referred to as being “connected” to another element, it may be “directly connected” to the other element or “electrically connected” to the other element with intervening elements therebetween. It will be further understood that when a part “includes” or “comprises” an element, unless otherwise defined, the part may further include other elements, not excluding the other elements.

The expression “the” and other similar words as this used in this specification, and in particular, in the claims, may refer to both a singular component and a plurality of components. Also, when an order in which operations included in a method of the disclosure are performed is not explicitly described, the operations may be performed in appropriate orders. The disclosure is not limited to a described order of the operations.

The expression “in some embodiments” or “according to an embodiment” described in various parts of this specification does not necessarily refer to the same embodiments.

Embodiments may be described in terms of functional block components and various processing steps. Some or all of such functional blocks may be realized by any number of hardware and/or software components configured to perform the specified functions. For example, the functional blocks may be embodied as one or more micro-processors or circuit components for certain functions. Also, for example, the functional blocks may be implemented with any programming or scripting language. The functional blocks may be realized by an algorithm executed by one or more processors. Furthermore, the disclosure could employ any number of related-art techniques for electronics configuration, signal processing and/or control, data processing and the like. The words “mechanism,” “element,” “device,” and “configuration” may be used broadly and are not limited to mechanical or physical embodiments.

Furthermore, the connecting lines, or connectors shown in the various figures presented are intended to represent example functional relationships and/or physical or logical couplings between the various elements. It should be noted that many alternative or additional functional relationships, physical connections or logical connections may be present in a practical device.

Hereinafter, the disclosure will be described in detail by referring to the accompanying drawings.

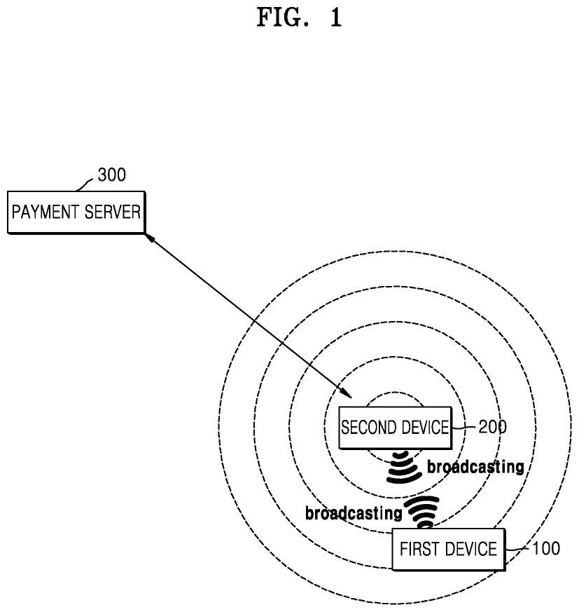

FIG. 1 is a schematic diagram illustrating an example of a payment system using short-range communication, according to embodiments.

Referring to FIG. 1, the payment system using short-range communication may include a first device 100, a second device 200, and a payment server 300.

In the payment system using short-range communication according to embodiments, the second device 200 may broadcast store identification data via the short-range communication and the first device 100 may broadcast payment data of a product to be purchased via the short-range communication. Here, the store identification data and the payment data may be broadcast between the first device 100 and the second device 200 which are not connected with each other for communication.

In some embodiments, the short-range communication used by the first device 100 and the second device 200 may include, for example, Bluetooth communication and Wi-Fi communication, but is not limited thereto. Also, the first device 100 and the second device 200 according to embodiments may perform short-range communication by using at least one of various Bluetooth communication methods, various Wi-Fi communication methods, a Zigbee communication method and an ANT communication method. The communication methods used by the first device 100 and the second device 200 may include, for example, Bluetooth ACL/HS, Bluetooth SCO/eSCO, Bluetooth low energy (BLE), Wi-Fi, Wi-Fi direct, Zigbee, and ANT, but are not limited thereto. Also, according to embodiments, types of data which may be exchanged between devices may vary based on a communication method, and the first device 100 and the second device 200 may select an appropriate communication method from among a plurality of communication methods, based on a type of data to be exchanged between each other.

Protocols of the BLE communication which may be used in the disclosure may be divided into a host protocol, which is a super ordinate protocol, and a controller protocol, which is a sub-ordinate protocol, wherein the protocols are divided into the super ordinate protocol and the sub-ordinate protocol based on a high controller interface (HCI). Also, for example, the host protocol may include L2cap, ATT, SMP, GAT, and GATT, and the controller protocol may include a link layer and a physical layer. For example, the second device 200 may broadcast a message including the store identification data by using the link layer. For example, the first device 100 may broadcast a message including the payment data of the product to be purchased by using the link layer.

The first device 100 located in a range of the short-range communication with respect to the second device 200, according to embodiments, may obtain the store identification data broadcast from the second device 200, and authenticate the second device 200. Here, the authenticating of the second device 200 may also denote authenticating a user of the second device 200. The first device 100 may authenticate the second device 200, for example, via a payment application installed in the first device 100.

Further, as the second device 200 is authenticated, the first device 100 may broadcast the payment data for purchasing the product by encrypting the payment data. The payment data may include, for example, product data of the product to be purchased and paying data for paying a price of the product.

The second device 200 may provide the payment data broadcast by the first device 100 to the payment server 300. The payment server 300 may approve payment of the product by using the payment data provided by the second device 200. The payment server 300 may include a banking server, a card company server, a virtual money (for example, bitcoin, gift cards, etc.) server, etc., which approves the payment by using the payment data provided from the second device 200 via a network. Also, the payment server 300 may include a management server configured to re-transmit the payment data provided from the second device 200 to an appropriate banking server, an appropriate card company server, an appropriate virtual money server, etc.

The first device 100 may include, but is not limited to, electronic devices, such as smartphones, tablet personal computers (PCs), PCs, smart televisions (TVs), cellular phones, personal digital assistants (PDAs), laptop computers, media players, global positioning system (GPS) devices, electronic book terminals, digital broadcasting terminals, navigation devices, kiosks, MP3 players, digital cameras, home appliances, and other mobile or non-mobile computer devices. Also, the first device 100 may include wearable electronic devices having a communication function and a data processing function, such as watches, glasses, hair bands, rings, etc.

Also, the second device 200 may be configured to perform short-range communication and may include beacon devices or electronic devices including beacon devices. Alternatively, the second device 200 may include point of sale (POS) devices including beacon devices. However, the second device 200 is not limited thereto, and may include all types of electronic devices that are capable of performing short-range communication.

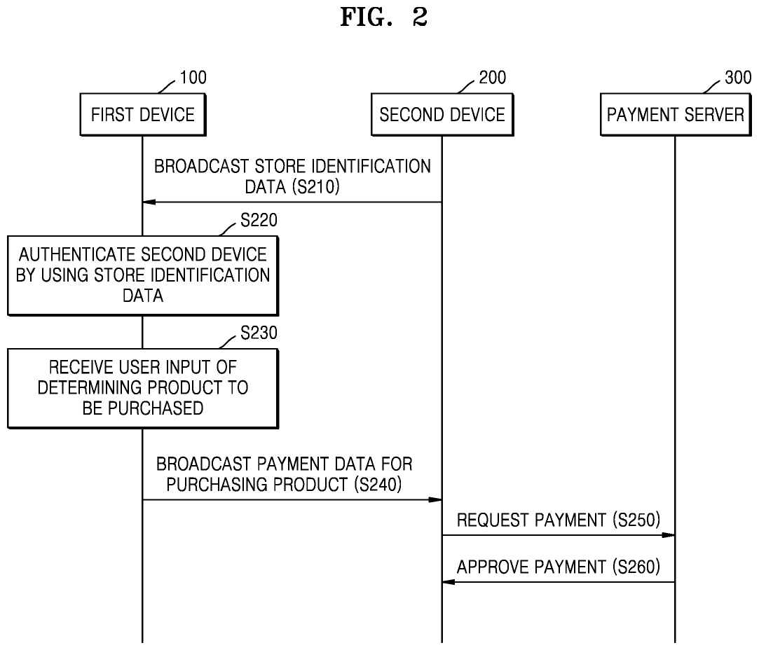

FIG. 2 is a flowchart of an operation method of the payment system using short-range communication, according to embodiments.

In operation S210, the second device 200 may broadcast store identification data. The store identification data may be at least one of a number, a letter, a sign, and a combination thereof for indicating a store in which the second device 200 is located. For example, the store identification data may be a value assigned from an authentication server 400 to be described below, and may be unique identification data (for example, a serial number, a multiple analog component (MAC) address, etc.) of the second device 200. Also, the store identification data may be beacon identification (ID) of a beacon device included in the second device 200. Meanwhile, the store identification data may be used to authenticate the second device 200.

Also, according to embodiments, the second device 200 may encrypt the store identification data by using a symmetric key encryption method or an asymmetric key encryption method, and may broadcast the encrypted store identification data. The symmetric key encryption method, whereby encryption/decryption is performed by using the same secret key (the symmetric key), may include, for example, data encryption standard (DES), triple DES (TDES), simple DES (SDES), advanced encryption standard (AES), Rivest Cipher x (RCx), SEED, ARIA, etc. Also, the asymmetric key encryption method, whereby encryption/decryption is performed by using different secret keys (a public key and a private key), may include, for example, Rivest Shamir Adleman (RSA), elliptic curve cryptosystem (ECC), Rabin, Schnorr, Diffle-Hallman, distal signature algorithm (DSA), Korean certificate-based digital signature algorithm (KCDSA), Fiat-Shamir, etc. The encryption methods described above may be easily understood by one of ordinary skill in the art, and thus, their detailed descriptions will not be given.

The first device 100 and the second device 200 may encrypt and decrypt the store identification data, etc., by using at least one of the encryption methods described above. However, the disclosure is not limited thereto, and the first device 100 and the second device 200 may encrypt/decrypt the store identification data, etc., by applying an encryption method not described above.

According to embodiments, the secret keys used for encryption/decryption may be values pre-stored in the first device 100 and the second device 200. For example, the first device 100 and the second device 200 may store the secret keys used for encryption/decryption, as a payment application is installed. Here, the secret keys may be stored in a pre-defined area (for example, a security area) of a memory of the first device 100 and the second device 200. Thus, the secret keys stored in the first device 100 and the second device 200 may be accessed only via the payment application installed in the first device 100 and the second device 200. Also, the secret keys stored in the first device 100 and the second device 200 may be updated as the payment application is updated.

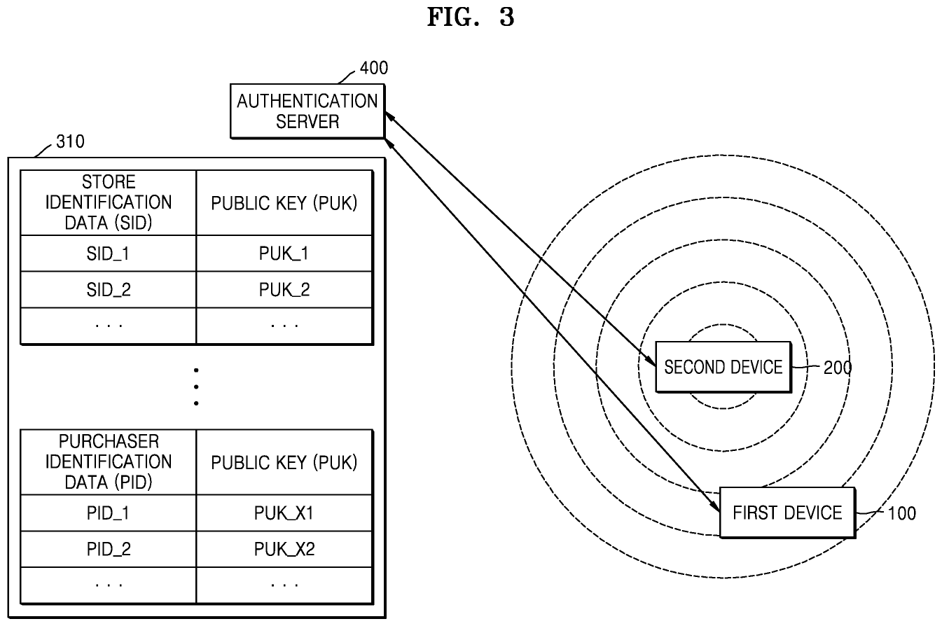

Alternatively, the secret keys may be obtained from the authentication server 400. A method, performed by the first device 100 and the second device 200, of obtaining the secret keys from the authentication server 400 will be described in detail after FIG. 3.

Also, in some embodiments, the second device 200 may further broadcast store identification data, a random number, etc., which are not encrypted, in addition to the encrypted store identification data. The store identification data, the random number, etc., which are not encrypted, may be used for the first device 100 to authenticate the second device 200.

In operation S220, the first device 100 may authenticate the second device 200 by using the store identification data broadcast from the second device 200.

In some embodiments, the first device 100 may authenticate the second device 200 by decrypting the encrypted store identification data. For example, the first device 100 may authenticate the second device 200 by comparing the store identification data obtained via the decryption with the store identification data which is broadcast from the second device 200 and not encrypted.

Alternatively, the first device 100 may request authentication of the second device 200 by providing the store identification data to the authentication server 400. In this case, the first device 100 may receive notification from the authentication server 400 that the second device 200 is authenticated.

Meanwhile, in some embodiments, the first device 100 may perform the encryption/decryption operations and the authentication operation via the payment application installed in the first device 100. The payment application may be a program configured to transmit and receive required information to and from at least one of the payment server 300 and the authentication server 400 connected with the first device 100 for communication, to authenticate the second device 200 and to perform an operation for purchasing a product sold in the store in which the second device 200 is located.

In operation S230, when the second device 200 is authenticated, the first device 100 may receive a user input of determining a product to be purchased.

In some embodiments, the first device 100 may provide a graphical user interface (GUI), via which a user may determine the product to be purchased. For example, the first device 100 may provide the GUI for determining the product to be purchased, via the payment application. Alternatively, the first device 100 may obtain, from the authentication server 400 or the second device 200, a universal resource locator (URL) for providing information about the store in which the second device 200 is located. In this case, the first device 100 may execute the URL on a web browser.

The first device 100 may receive the user input of determining the product to be purchased, via the GUI provided by the payment application or the web browser on which the URL is executed.

When the user input is received, the first device 100 may obtain product data of the product determined to be purchased via the payment application or the URL. The product data may include, for example, at least one of product identification data and product price data.

In operation S240, the first device 100 may broadcast payment data for purchasing the determined product, via short-range communication. Here, the payment data may include the product data of the product to be purchased and paying data for paying a price of the product. The paying data may include at least one of a card (for example, a credit card, a cash card, a mobile card, etc.,) number, a card expiration date, a check number, a bank account number, and a combination thereof, stored in the first device 100. Also, the paying data may be a value generated by combining the card number, etc., stored in the first device 100, with a random number. Also, the paying data may be obtained from the payment server 300.

In some embodiments, the first device 100 may encrypt the payment data by using at least one of the encryption methods described with reference to operation S220, and broadcast the encrypted payment data. For example, the first device 100 may encrypt the payment data by using a public key of a user of the second device 200. Thus, the encrypted payment data may be decrypted only by using a private key of the user of the second device 200, the private key being stored in the second device 200. Thus, the broadcast payment data may be provided to the second device 200.

As described above, the first device 100 and the second device 200 according to embodiments may broadcast the store identification data and the payment data required to pay for a product, via the short-range communication, and thus, may not perform an operation (for example, a pairing operation) for connecting each other for communication. Via this, it may be prevented that the devices located within a range of short-range communication are unnecessarily connected with each other for communication.

FIG. 3 illustrates an example in which the payment system according to embodiments manages key data of devices via the authentication server 400.

Referring to FIG. 3, the payment system may further include the authentication server 400, in addition to the first device 100, the second device 200, and the payment server 300 described in FIG. 1.

In some embodiments, the authentication server 400 may be connected with the first device 100 and the second device 200 and may transmit and receive data to and from the first device 100 and the second device 200 based on bi-directional communication. For example, the first device 100 and the second device 200 may be connected with the authentication server 400 via Internet protocol (IP) communication, but it is not limited thereto. In addition, the first device 100 and the second device 200 may transmit and receive data to and from the authentication server 400, via various communication protocols, such as HTTP, FTP, etc.

Also, the authentication server 400 may store and manage the secret keys used by the first device 100 and the second device 200 to encrypt/decrypt data. For example, referring to the table 310 of FIG. 3, the authentication server 400 may store and manage store identification data SID and a public key PUK corresponding to the store identification data SID.

Also, according to embodiments, the authentication server 400 may further store and manage store data corresponding to the store identification data SID. The store data may include, for example, a name of a store corresponding to at least one piece of the store identification data SID, product identification data with respect to products sold in a store, price data with respect to products sold in a store, discount coupon data provided by a store, data of events promoted in a store, etc. Alternatively, the store data may include an URL for providing at least one of the pieces of the data described above.

Also, according to embodiments, the authentication server 400 may store and manage purchaser identification data PID and a public key PUK corresponding to the purchaser identification data PID.

When the authentication server 400 receives, from the first device 100 (or the second device 200), a message requesting a public key PUK of a user of the other device, the authentication server 400 may provide the public key PUK of the user of the other device corresponding to the message, to the first device 100 (or the second device 200). Here, the message transmitted and received between the authentication server 400 and the first device 100 (or the second device 200) may be encrypted by using a session key SSK that is pre-set between the authentication server 400 and the first device 100 (or the second device 200).

Alternatively, when the first device 100 and the second device 200 encrypt/decrypt the data by using a symmetric key SMK, the authentication server 400 may store and manage the symmetric key SMK of the first device 100 and the second device 200. For example, when the second device 200 is authenticated, the first device 100 may request the symmetric key SMK with the second device 200 from the authentication server 400. The authentication server 400 may provide the symmetric key SMK with the second device 200 pre-stored in the authentication server 400 to the first device 100. Alternatively, the authentication server 400 may generate a temporary symmetric key SMK and provide the generated symmetric key SMK to the first device 100 and the second device 200. Here, the temporary symmetric key SMK may denote a symmetric key discarded after being used by a predetermined number of times or discarded after being used for a predetermined time period.

Also, when the first device 100 requests the authentication server 400 to authenticate the second device 200, the authentication server 400 may authenticate the second device 200. For example, when the authentication server 400 receives encrypted store identification data from the first device 100, the authentication server 400 may authenticate the second device 200 by comparing the store identification data decrypted by the authentication server 400 with store identification data pre-stored in the authentication server 400. Also, the authentication server 400 may notify the first device 100 of a result of the authentication.

Also, the authentication server 400 may receive a request of authenticating the first device 100, from the second device 200, and notify the second device 200 of a result of the authentication.

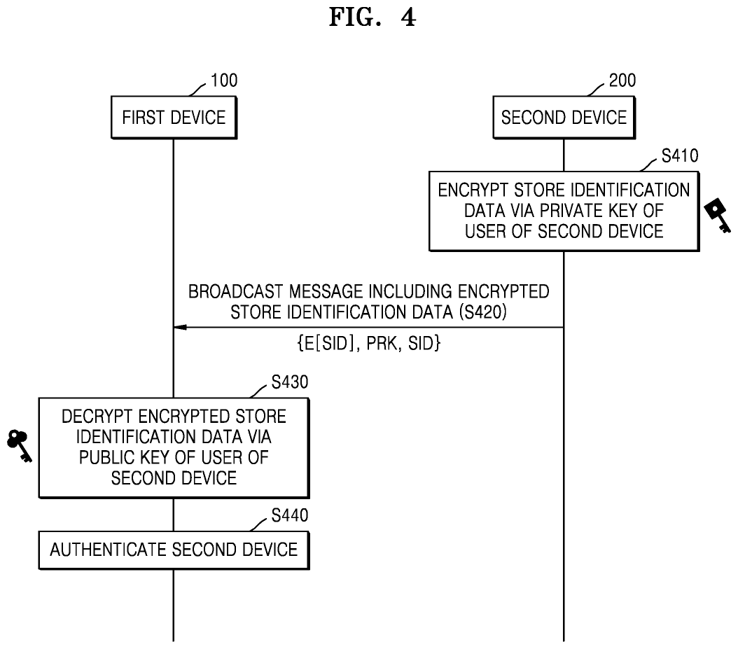

FIG. 4 is a flowchart of a method, performed by the first device 100, of authenticating the second device 200 by using a message broadcast from the second device 200, according to embodiments.

In operation S410, the second device 200 may encrypt the store identification data SID by using a private key PRK of a user of the second device 200. The private key PRK of the user of the second device 200 may be stored in the second device 200 and may be obtained from the authentication server 400.

In operation S420, the second device 200 may broadcast a message including the store identification data SID encrypted using the private key PRK of the user of the second device 200 and non-encrypted store identification data SID. The message may include, for example, beacon data broadcast by using a BLE communication protocol. Also, the message may further include the non-encrypted store identification data SID.

In operation S430, the first device 100, which is located within a range of communication with the second device 200, may decrypt the encrypted store identification data SID included in a first message, by using a public key PUK of the user of the second device 200.

In some embodiments, the public key PUK of the user of the second device 200 may be obtained via the payment application installed in the first device 100. For example, the first device 100 may request the public key PUK of the user of the second device 200 from the authentication server 400, via the payment application, in order to obtain the public key PUK of the user of the second device 200.

Alternatively, the first device 100 may obtain the public key PUK of the user of the second device 200, the public key PUK being stored in the first device 100, via the payment application. For example, the public key PUK of the user of the second device 200 may be stored in a pre-determined area (for example, a security area) of a memory of the first device 100. The first device 100 may pre-set a password for accessing the memory area in which the public key PUK is stored, and may provide a GUI for receiving, from a user of the first device 100, an input of the password, via the payment application.

In operation S440, the first device 100 may authenticate the second device 200. The first device 100 may authenticate the second device 200 by comparing the store identification data SID obtained via the decryption in operation S430 with the store identification data SID of the second device 200.

In some embodiments, the first device 100 may authenticate the second device 200 by comparing the store identification data SID broadcast from the second device 200 and non-encrypted with the store identification data SID decrypted by the first device 100.

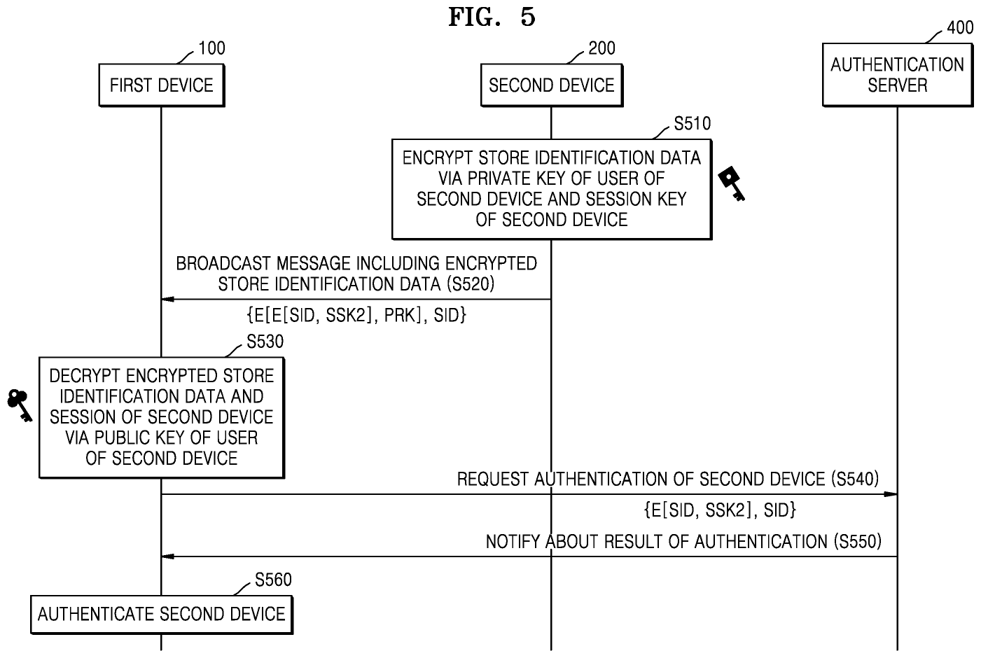

FIG. 5 is a flowchart of a method, performed by the first device, of authenticating the second device 200 by using a message broadcast from the second device 200, according to embodiments.

In operation S510, the second device 200 may encrypt the store identification data SID by using the private key PRK of the user of the second device 200 and a session key SSK2 of the second device 200. Here, the session key SSK2 of the second device 200 may be a value that is set between the second device 200 and the authentication server 400.

In operation S520, the second device 200 may broadcast a message including the encrypted store identification data SID and the session key SSK2 of the second device 200. The message may be, for example, beacon data broadcast by using a BLE communication protocol. Also, the message may further include non-encrypted store identification data SID.

In operation S530, the first device 100, which is located within a range of communication with the second device 200, may decrypt the encrypted store identification data SID and the session key SSK2 of the second device 200, by using the public key PUK of the user of the second device 200.

In operation S540, the first device 100 may request the authentication server 400 to authenticate the second device 200. The first device 100 may transmit an authentication request message including the store identification data SID obtained via the decryption in operation S530, to the authentication server 400. Here, the store identification data SID obtained via the decryption may be the store identification data SID encrypted using the session key SSK2 of the second device 200.

Also, the first device 100 may encrypt the authentication request message to be transmitted to the authentication server 400, by using a session key SSK1 of the first device 100. Here, the session key SSK1 of the first device 100 may be a value that is set between the first device 100 and the authentication server 400.

When the authentication server 400 receives the authentication request message from the first device 100, the authentication server 400 may notify the first device 100 of an authentication result with respect to the second device 200, in operation S550. The received store identification data SID may be encrypted by using the session key SSK2 of the second device 200 in operation S510. Thus, the authentication server 400 may decrypt the received store identification data SID by using the session key SSK2 of the second device 200. The authentication server 400 may authenticate the second device 200 by comparing the store identification data SID obtained via the decryption with the store identification data SID stored in the authentication server 400.

Alternatively, when the authentication request message encrypted using the session key SSK1 of the first device 100 is received by the authentication server 400, the authentication server 400 may decrypt the received store identification data SID received by using the session key SSK1 of the first device 100 and then may decrypt again the store identification data SID by using the session key SSK2 of the second device 200.

In operation S560, the first device 100 may authenticate the second device 200 based on the notification from the authentication server 400. When the second device 200 is authenticated, the first device 100 may provide a GUI indicating identification data of the second device 200.

Meanwhile, it is described above that the store identification data SID is encrypted by using the session key SSK2 of the second device 200. However, the disclosure is not limited thereto. In some embodiments, the second device 200 may broadcast the store identification data SID encrypted by using a random number.

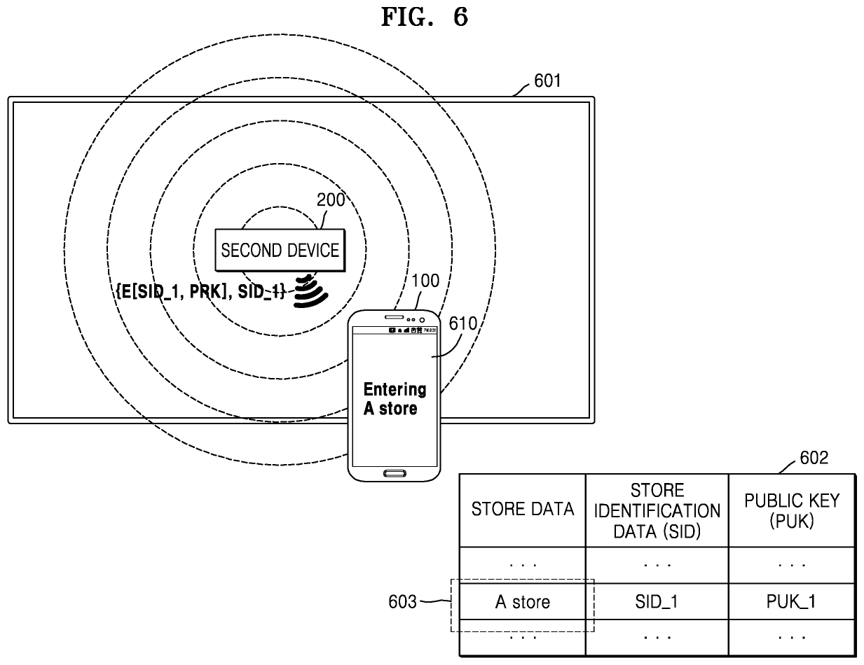

FIG. 6 illustrates an example in which the first device 100 provides data about a store in which the second device 200 is located.

Referring to FIG. 6, as the first device 100 is located within a range of communication with the second device 200, the first device 100 may obtain a public key PUK_1 of the user of the second device 200 by using store identification data SID_1 broadcast from the second device 200. For example, the first device 100 may obtain the public key PUK_1 of the user of the second device 200 by using a table 602 including the store identification data SID stored in the authentication server 400, the public key PUK corresponding to the store identification data SID, and store data. Alternatively, the table 602 may be stored in the first device 100.

The first device 100 may decrypt the encrypted store identification data SID by using the public key PUK_1 of the user of the second device 200, and may compare the store identification data SID obtained via the decryption with the store identification data SID_1 broadcast from the second device 200.

When the store identification data SID obtained via the decryption and the store identification data SID_1 broadcast from the second device 200 correspond to each other based on the comparison, the first device 100 may authenticate the second device 200 and may obtain, from the table 602, store data 603 corresponding to the store identification data SID_1 of the second device 200. For example, the store data 603 may include a name of a store in which the second device 200 is located.

The first device 100 may provide a GUI 610 indicating that the first device 100 “enters into a store A” by using the obtained store data 603.

When the store data stored in the authentication server 400 or the first device 100 is a URL including data about the store, the first device 100 may execute the URL via a web browser, thereby providing the data about the store.

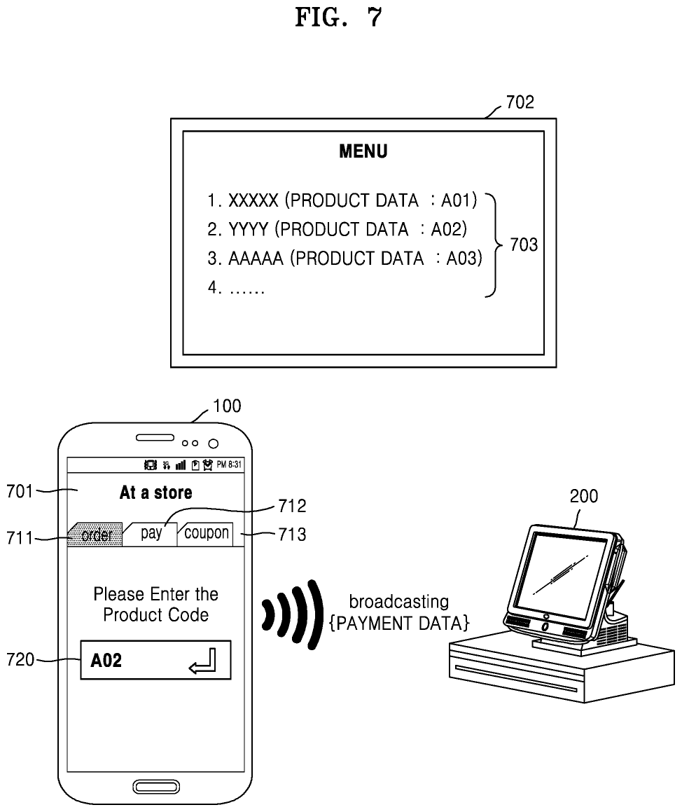

FIGS. 7 and 8 illustrate examples of a GUI via which the first device 100 receives a user input of determining a product to be purchased.

Referring to FIG. 7, as the first device 100 is located within a range of communication with the second device 200, the first device 100 may provide the GUI for receiving the user input of determining the product to be purchased.

In some embodiments, the first device 100 may provide the GUI 610 indicating the store data 603 of FIG. 6, and then, may convert a screen and provide a GUI 701 of FIG. 7. The GUI 701 of FIG. 7 may include, for example, an order page 711 for receiving a user input of inputting product data of a product to be purchased, a pay page 712 for receiving a user input of inputting paying data of the product to be purchased, and a coupon page 713 for providing coupons of products that are sold.

The order page 711 may include, for example, a GUI 720 for inputting product data with respect to products sold in the “store A.” Thus, the first device 100 may receive a user input of inputting one of pieces of product data 703 with respect to the products sold in the “store A.”

Alternatively, the order page 711 may include, for example, a GUI 820 for providing a list of the products sold in the “store A,” as illustrated in FIG. 8. In this case, the first device 100 may receive a user input of selecting one from the list of the products. Alternatively, the order page 711 may include an execution screen (for example, a web-browser execution screen) of an URL including the data with respect to the products sold in the “store A.” The order page 711 is not limited thereto and may include various GUIs for determining the product to be purchased.

Referring to FIG. 7 again, when the user input of determining the product to be purchased is received, the first device 100 may broadcast payment data. The payment data may include product data of the product to be purchased and paying data for paying a price of the product to be purchased. Hereinafter, embodiments, according to which the first device 100 broadcasts the product data and the paying data, will be described in detail.

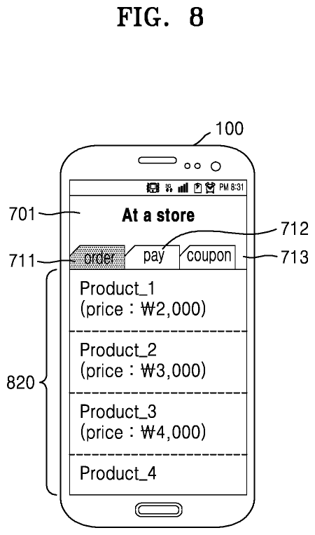

FIG. 9 is a flowchart of a method, performed by the first device 100, of purchasing a product by broadcasting payment data.

In operation S910, the first device 100 may obtain paying data. Here, the paying data may include data for paying a price of a product determined by the first device 100. The paying data may include, for example, at least one of a card (for example, a credit card, a cash card, a mobile card, etc.) number, a card expiration date, a check number, a bank account number, and a combination thereof.

In some embodiments, the first device 100 may obtain the paying data stored in the first device 100. The first device 100 may obtain the paying data stored in a predetermined area (for example, a security area) of a memory of the first device 100, via a payment application. For example, the first device 100 may obtain at least one of the card number, the card expiration date, the check number, the bank account number, and the combination thereof stored in the first device 100. Also, the first device 100 may combine the obtained paying data (for example, the card number) with a random number.

Alternatively, the first device 100 may request the paying data of the first device 100 from the payment server 300. For example, the first device 100 may transmit a paying data request message including purchaser identification data PID of the first device 100, to the payment server 300. Here, the purchase identification data PID provided to the payment server 300 may be encrypted by using a session key, etc., pre-set between the first device 100 and the payment server 300.

The payment server 300 may provide temporary paying data to the first device 100 by using identification data of the first device 100. Here, the temporary paying data may denote paying data discarded after being used by a predetermined number of times or after being used for a predetermined time period. For example, the payment server 300 may generate temporary paying data by combining the card number of the user of the first device 100, the care number being registered in the payment server 300, with a random number, and may transmit the generated paying data to the first device 100.

According to embodiments, when a plurality of pieces of the paying data are stored in the first device 100, the first device 100 may provide a GUI for determining at least one of the plurality of pieces of the paying data. Alternatively, the first device 100 may select one of a plurality of payment servers and obtain the temporary paying data from the selected payment server.

In operation S920, the first device 100 may encrypt the payment data including the obtained paying data and product data. Here, the product data may include at least one of product identification data of a product determined based on a user input received by the first device 100, and product price data. The first device 100 may encrypt the payment data by using at least one of the symmetric key encryption methods and the asymmetric key encryption methods described above in operation S210 of FIG. 2. For example, the first device 100 may encrypt the payment data by using the symmetric key SMK pre-set between the first device 100 and the second device 200. Alternatively, the first device 100 may encrypt the payment data by using the public key PUK of a user of the second device 200. However, the disclosure is not limited thereto, and the first device 100 may encrypt the payment data by using various encryption methods.

In operation S930, the first device 100 may broadcast the encrypted payment data. Also, the first device 100 may broadcast the purchaser identification data PID of the first device 100, the purchaser identification data PID not being encrypted, together with the encrypted payment data. The non-encrypted purchaser identification data PID of the first device 100 may be used for the second device 200 to obtain the public key PUK of the user of the first device 100.

Also, in some embodiments, the first device 100 may encrypt the purchaser identification data PID of the first device 100 and broadcast the encrypted purchaser identification data PID. The purchaser identification data PID obtained via the encryption and non-encrypted purchaser identification data PID may be used for the second device 200 to authenticate the first device 100. Meanwhile, methods of authenticating the first device 100 via the second device 200 may apply the embodiments described above with reference to FIGS. 3 through 5, and thus, their detailed descriptions will be omitted.

In operation S940, the second device 200 may decrypt the encrypted payment data. For example, the second device 200 may decrypt the encrypted payment data by using the symmetric key SMK with the first device 100. Alternatively, the second device 200 may decrypt the encrypted payment data by using the private key PKU of the user of the second device 200.

In operation S950, the second device 200 may transmit a payment request message to the payment server 300, by using the payment data obtained via the decryption. The payment request message may be encrypted by using a session key set between the second device 200 and the payment server 300. Also, in operation S960, the second device 200 may receive a payment approval message from the payment server 300.

Alternatively, in some embodiments, the second device 200 may encrypt the payment approval message obtained from the payment server 300 by using the public key PUK of the user of the first device 100, and broadcast the encrypted payment approval message. Thus, the first device 100 may obtain the payment approval message.

Alternatively, the payment server 300 may provide the payment approval message to the first device 100. For example, the payment server 300 may provide the payment approval message to the first device 100 in various formats, such as a text message, an SMS message, an email message, etc., by using the identification data of the first device 100, the identification data being stored in the payment server 300.

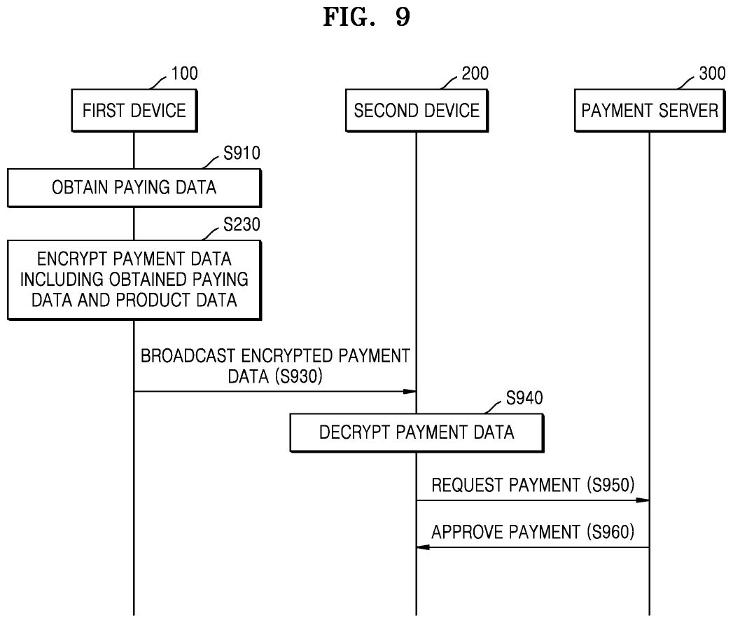

FIG. 10 is a flowchart of a method, performed by the first device 100, of broadcasting the payment data.

In operation S1010, the first device 100 may obtain the symmetric key SMK with the second device 200. The first device 100 may obtain the symmetric key SMK stored in the first device 100, or may obtain the symmetric key SMK with the second device 200 from the authentication server 400.

In some embodiments, the first device 100 may store symmetric keys in a pre-defined area (for example, a security area) of a memory of the first device 100. For example, as a payment application is installed in the first device 100, the first device 100 may store the symmetric keys in the memory of the first device 100. In this case, the stored symmetric keys may be updated when the payment application is updated, or may be periodically updated.

When the second device 200 is authenticated, the first device 100 may determine the symmetric key SMK corresponding to the store identification data of the second device 200, from among the symmetric keys stored in the first device 100.

Alternatively, the first device 100 may obtain the symmetric key SMK with the second device 200 from the authentication server 400. For example, when the second device 200 is authenticated, the first device 100 may request the symmetric key SMK with the second device 200 from the authentication server 400. The authentication server 400 may provide the symmetric key SMK pre-stored in the authentication server 400, or may generate a temporary symmetric key SMK and provide the generated symmetric key SMK to the first device 100 and the second device 200, when the request is received from the first device 100.

In operation S1020, the first device 100 may broadcast a message including the payment data encrypted using the symmetric key SMK. Here, the message may be, for example, beacon data broadcast by using a BLE communication protocol.

Also, in some embodiments, the first device 100 may broadcast the payment data and the purchaser identification data PID of the first device 100 by encrypting the payment data and the purchaser identification data PID of the first device 100 by using the symmetric key SMK. In this case, the broadcast message may further include the purchaser identification data PID, which is not encrypted. The encrypted purchaser identification data PID and the non-encrypted purchaser identification data PID may be used for the second device 200 to authenticate the first device 100.

In operation S1030, the second device 200 may decrypt the encrypted payment data by using the symmetric key SMK with the first device 100. The second device 200 may determine one from among symmetric keys stored in the second device 200 by using the purchaser identification data PID of the first device 100. Alternatively, the second device 200 may obtain the symmetric key SMK with the first device 100 from the authentication server 400. For example, the second device 200 may request the symmetric key SMK with the first device 100 from the authentication server 400, and may receive, from the authentication server 400, the temporary symmetric key SMK generated in response to the request of the first device 100.

The second device 200 may decrypt the encrypted payment data by using the obtained symmetric key SMK. Also, the second device 200 may authenticate the first device 100 by comparing the purchaser identification data PID obtained via the decryption with the purchaser identification data PID of the first device 100. When the first device 100 is not authenticated, the second device 200 may delete the symmetric key SMK and request the authentication server 400 to discard the symmetric key SMK with the first device 100.

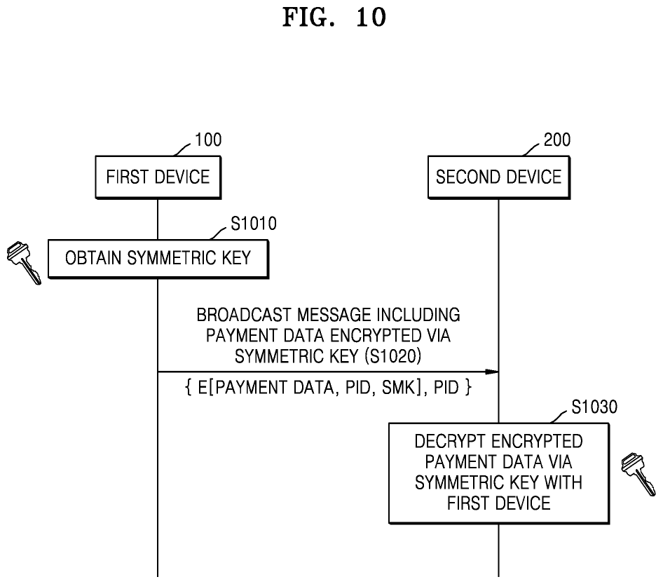

FIG. 11 is a flowchart of another method, performed by the first device 100, of broadcasting the payment data.

In operation S1110, the first device 100 may encrypt the payment data by using the public key PUK of the user of the second device 200. The public key PUK of the user of the second device 200 may be obtained from the authentication server 400. Alternatively, the public key PUK of the user of the second device 200 may be pre-stored in the first device 100.

In operation S1120, the first device 100 may broadcast a message including the payment data encrypted using the public key PUK of the user of the second device 200. The message may be, for example, beacon data broadcast by using a BLE communication protocol.

In some embodiments, the first device 100 may encrypt the payment data and the purchaser identification data PID of the first device 100 by using the public key PUK of the user of the second device 200 and broadcast the encrypted payment data and the encrypted purchaser identification data PID. In this case, the broadcast message may further include the purchaser identification data PID of the first device 100, which is not encrypted. The encrypted purchaser identification data PID and the non-encrypted purchaser identification data PID may be used for the second device 200 to authenticate the first device 100.

In operation S1130, the second device 200 may decrypt the encrypted payment data by using a private key PRK of the user of the second device 200. Also, the second device 200 may authenticate the first device 100 by comparing the purchaser identification data obtained via the decryption with the non-encrypted purchaser identification data PID.

When the first device 100 is not authenticated, the second device 200 may not perform operation S950, etc., of FIG. 9. Also, when the first device 100 is not authenticated, the second device 200 may broadcast an authentication fail message encrypted using the public key PUK of the user of the first device 100.

The payment data decrypted by the second device 200 in operations S1030 and S1130 of FIG. 10 may be provided to the payment server 300. The payment data may be used by the payment server 300 to approve the payment of a product. Also, the second device 200 may provide, to the payment server 300, data required by the payment server 300 to approve the payment of the product.

Meanwhile, when the payment data is received from the second device 200, the payment server 300 may request the authentication data of the first device 100 to from the first device 100, in order to approve the payment.

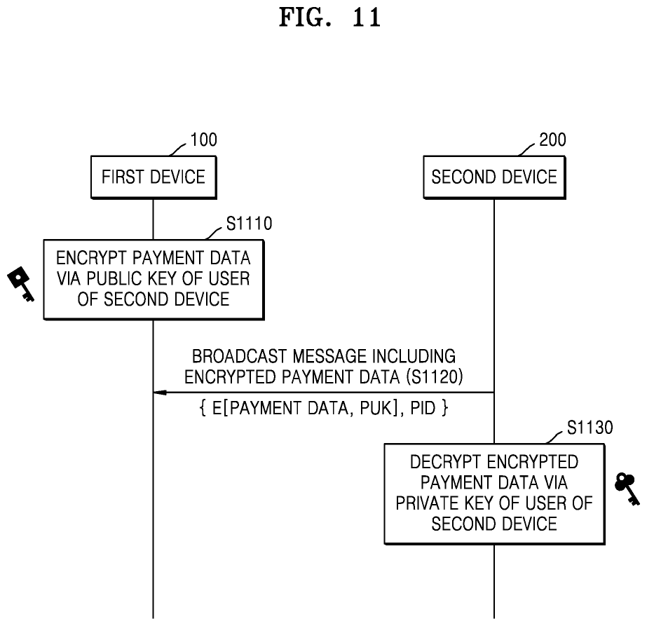

FIG. 12 is a flowchart of a method, performed by the first device 100, of providing the authentication data of the first device 100 to the payment server 300, in response to a request of the payment server 300.

In operations S1210 and S1220, when the second device 200 provides the payment data to the payment server 300, the payment server 300 may request the authentication data from the first device 100, based on the payment data provided from the second device 200. The authentication data of the first device 100 may include ID of the first device 100, a password of the first device 100, or biometric data of the user of the first device 100, pre-registered in the payment server 300.

In operation S1230, the first device 100 may obtain the authentication data of the first device 100. For example, the first device 100 may provide a GUI for receiving an input of the ID of the first device 100, the password of the first device 100, or the biometric data (for example, a voice, a fingerprint, an iris, a face, etc.) of the user of the first device 100. Also, the first device 100 may encrypt the data input via the provided GUI, by using a session key SSK that is set between the first device 100 and the payment server 300.

In operation S1240, the first device 100 may transmit the encrypted authentication data of the first device 100 to the payment server 300. The payment server 300 may decrypt the received authentication data by using the session key SSK of the payment server 300.

In operation S1250, when the authentication data obtained via the decryption corresponds to the ID of the first device 100, the password of the first device 100, or the biometric data, pre-stored in the payment server 300, the payment server 300 may approve the payment of a product. Also, the payment server 300 may transmit a message indicating that the payment is approved, to the second device 200. Also, the payment server 300 may transmit a message that the payment is approved, to the first device 100.

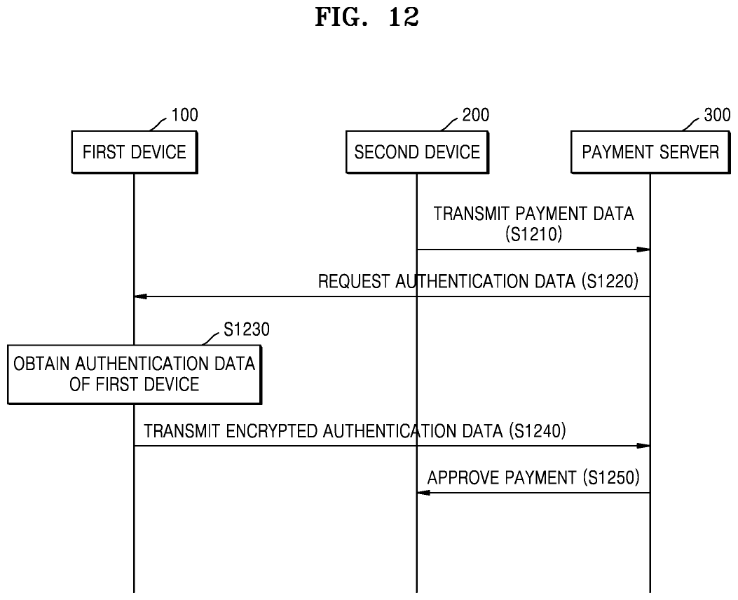

FIG. 13 illustrates an example in which the first device 100 provides a GUI for receiving a user input of determining paying data of a product to be purchased.

Referring to FIG. 13, the first device 100 may provide the GUI for receiving the user input of selecting one from among a plurality of pieces of the paying data pre-stored in the first device 100. For example, the first device 100 may provide a list 1311 of the plurality of pieces of the paying data via the pay page 712 of FIG. 7, as illustrated in the left figure of FIG. 13. Also, the first device 100 may receive the user input of selecting one from among the list 1311 of the plurality of pieces of the paying data. For example, when the user input of selecting a “W card” is received, the first device 100 may broadcast the paying data generated by using at least one of a card number of the W card, a card expiration date of the W card, and a random number, and product data of the product to be purchased, by encrypting the paying data and the product data by using the public key PUK of the user of the second device 200.

Also, when the first device 100 obtains a message that the payment of the product is approved, from the second device 200 or the payment server 300, the first device 100 may provide at least one of a GUI 1312 indicating that the product is purchased by using the W card,” a GUI 1313 indicating an order number for receiving the product, and a GUI 1314 for receiving an input of canceling the purchase of the product, via the pay page 712, as illustrated in the right figure of FIG. 13. However, the disclosure is not limited thereto. The first device 100 may provide a GUI indicating information about a purchased product, and may provide other GUIs indicating various information.

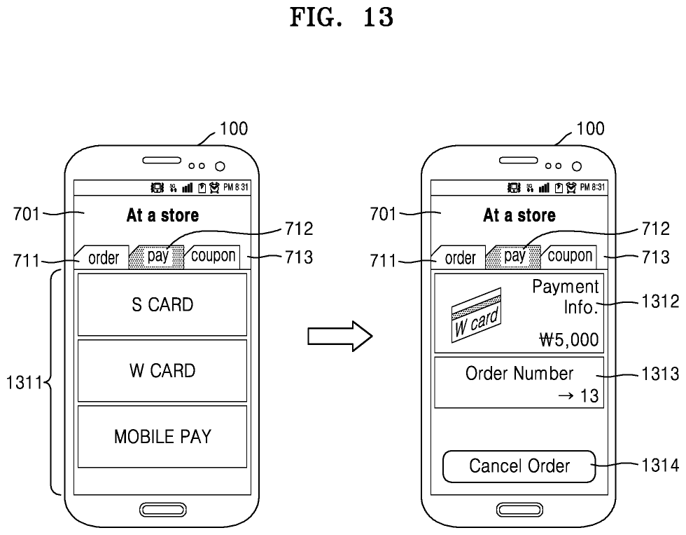

FIG. 14 illustrates an example in which the payment system manages store data corresponding to the second device 200 via the authentication server 400, according to embodiments.

Referring to FIG. 14, the authentication server 400 may further store and manage the store data corresponding to the store identification data SID, in addition to the store identification data SID and the public key PUK corresponding to the store identification data SID. The store data may include, for example, a name of a store corresponding to at least one piece of the store identification data SID, product identification data with respect to products sold in a store, price data with respect to products sold in a store, discount coupon data provided by a store, data about an event promoted by a store, etc. Alternatively, the store data may include a URL for providing at least one of the pieces of the data described above.

According to an embodiment, when the second device 200 broadcasts store identification data SID_1 of the second device 200 by encrypting the store identification data SID_1 by using a private key PRK_1 of the user of the second device 200, the first device 100 may authenticate the second device 200 by using a public key PUK_1 of the user of the second device 200, the public key PUK_1 being obtained from the authentication server 400. When the second device 200 is authenticated, the first device 100 may obtain store data URL_1 corresponding to the store identification data SID_1 of the second device 200, from the authentication server 400. Also, the first device 100 may execute the obtained store data URL_1 by using a web browser.

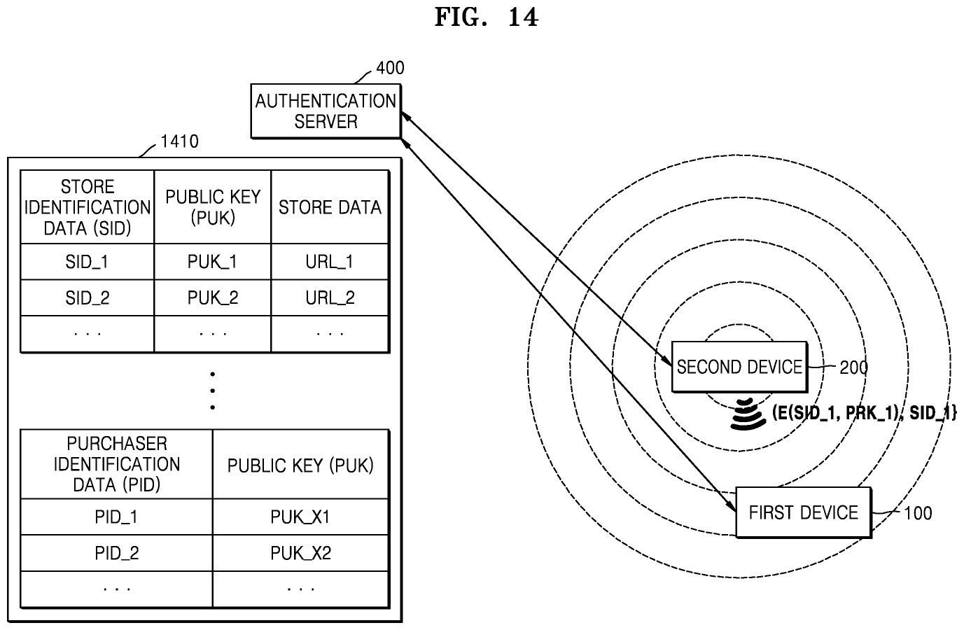

FIG. 15 illustrates an example in which the first device 100 executes the URL obtained from the authentication server 400.

Referring to FIG. 15, the first device 100 may execute the URL obtained from the authentication server 400 via a payment application. An execution screen 1501 on which the URL is executed may include data of an event promoted by a store in which the second device 200 is located. Also, the execution screen 1501 on which the URL is executed may include a GUI 1502 for receiving a user input of purchasing a product sold in the store in which the second device 200 is located.

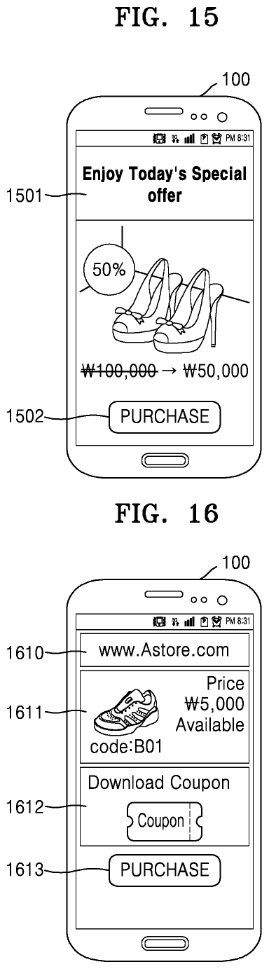

FIG. 16 illustrates another example in which the first device 100 executes the URL obtained from the authentication server 400.

Referring to FIG. 16, the first device 100 may execute the URL obtained from the authentication server 400 via web-browser. An execution screen 1610 on which the URL is executed may include a GUI 1611 indicating information about a product sold in a store in which the second device 200 is located, a GUI 1612 for downloading a coupon related to a product, and a GUI 1613 for receiving a user input of purchasing a product.

Meanwhile, it is described in FIGS. 14 through 16 that the first device 100 obtains the store data corresponding to the second device 200 from the authentication server 400. However, in some embodiments, the first device 100 may obtain the store data corresponding to the second device 200 from data that is broadcast from the second device 200.

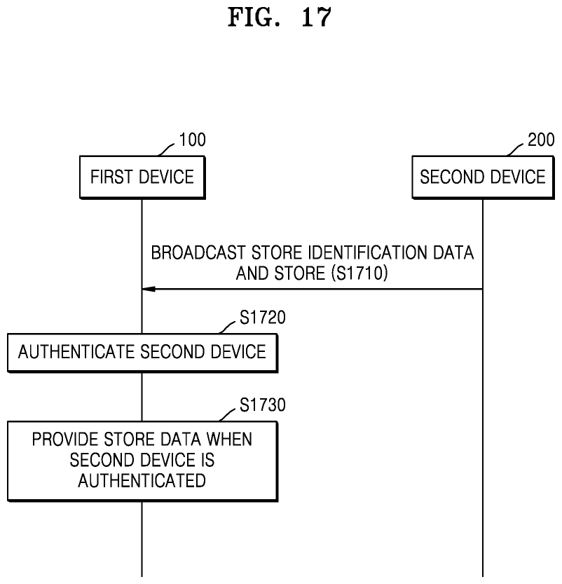

FIG. 17 is a flowchart of a method, performed by the first device 100, of obtaining the store data of the second device 200, according to embodiments.

In operation S1710, the second device 200 may broadcast the store identification data and the store data. The second device 200 may encrypt the store identification data and the store data by using at least one of the symmetric key encryption methods and the asymmetric key encryption methods. Also, the second device 200 may broadcast the encrypted store identification data and the encrypted store data.

In operation S1720, the first device 100, which is located in a range of short-range communication with respect to the second device 200, may authenticate the second device 200.

In operation S1730, when the second device 200 is authenticated, the first device 100 may provide the store data broadcast from the second device 200. For example, when the store data is URL data, the first device 100 may display an execution screen of the URL via a web-browser or a payment application.

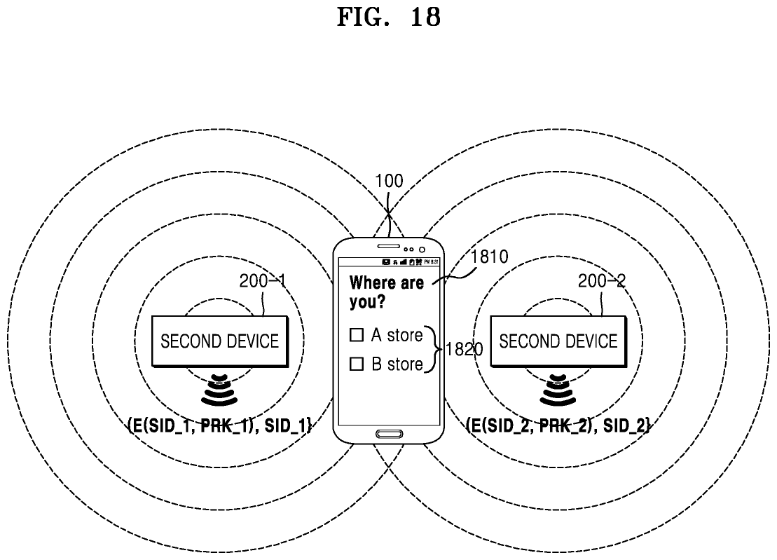

FIG. 18 illustrates an example in which the first device 100 authenticates at least one second device when there are a plurality of second devices 200-1 and 200-2, according to embodiments.

Referring to FIG. 18, the first device 100, which is located in a range of short-range communication with respect to the plurality of second devices 200-1 and 200-2, may obtain a plurality of pieces of store identification data SID_1 and SID_2 broadcast from the plurality of second devices 200-1 and 200-2.

When the plurality of pieces of the store identification data SID_1 and SID_2 are obtained, the first device 100 may provide a GUI 1810 for receiving a user input of selecting at least one of the plurality of pieces of the store identification data SID_1 and SID_2. For example, the GUI 1810 may include a list 1820 of stores corresponding to the plurality of pieces of the store identification data SID_1 and SID_2. The first device 100 may provide the list 1820 by obtaining store data corresponding to each of the plurality of pieces of the store identification data SID_1 and SID_2 from the first device 100 or the authentication server 400.

Also, when at least one of the list 1820 is selected, the first device 100 may authenticate the second device corresponding to the selected store identification data.

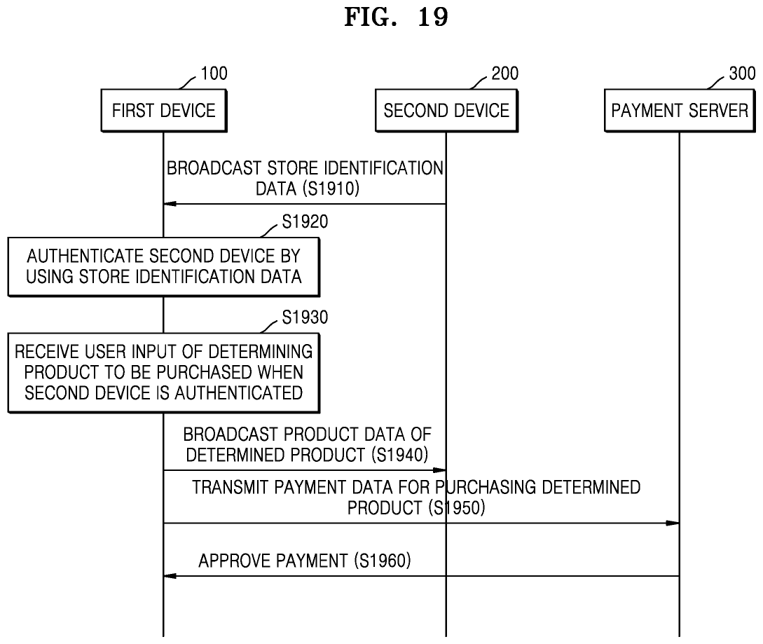

FIG. 19 is a flowchart of an operation method of the payment system using short-range communication, according to embodiments.

In operation S1910, the second device 200 may broadcast the store identification data. The store identification data may be at least one of a number, a letter, a sign, and a combination thereof for indicating a store in which the second device 200 is located. For example, the store identification data may be a value assigned from the authentication server 400, and may be unique identification data (for example, a serial number, an MAC address, etc.) of the second device 200. Also, the store identification data may be beacon ID of a beacon device included in the second device 200.

Also, in some embodiments, the second device 200 may encrypt the store identification data by using a symmetric encryption method or an asymmetric encryption method, and may broadcast the encrypted store identification data. Embodiments in which the second device 200 encrypts the store identification data may include the embodiments described in operation S410 of FIG. 4 and operation S510 of FIG. 5, and thus, their detailed descriptions will be omitted.

In operation S1920, the first device 100 may authenticate the second device 200 by using the store identification data broadcast from the second device 200. In some embodiments, the first device 100 may authenticate the second device 200 by decrypting the encrypted store identification data. Embodiments in which the first device 100 authenticates the second device 200 may include the embodiments described in operations S430 and S440 of FIG. 4 and operations S530 through S560 of FIG. 5, and thus, their detailed descriptions will be omitted.

In operation S1930, when the second device 200 is authenticated, the first device 100 may receive a user input of determining a product to be purchased.

In some embodiments, the first device 100 may provide a GUI via which a user may determine the product to be purchased. For example, the first device 100 may provide the GUI for determining the product to be purchased via a payment application. Alternatively, the first device 100 may obtain an URL for providing data about a store in which the second device 200 is located, from the authentication server 400. In this case, the first device 100 may execute the URL via a web-browser.

The first device 100 may receive the user input of determining the product to be purchased, via the GUI provided by the payment application or via the web-browser on which the URL is executed.

In operation S1940, the first device 100 may broadcast the product data of the determined product. The product data may include at least one of product identification data and product price data. The first device 100 may encrypt the product data by using the symmetric key encryption method or the asymmetric encryption method with respect to the second device 200 and may broadcast the encrypted product data. For example, the first device 100 may encrypt the product data by using the symmetric key with the second device 200 and broadcast the encrypted product data. Alternatively, the first device 100 may encrypt the product data by using the public key PUK of the user of the second device 200 and broadcast the encrypted product data.

In operation S1950, the first device 100 may transmit the payment data for purchasing the determined product to the payment server 300. Here, the payment data may include the product data and the paying data for paying a price of the product. Also, the paying data may include at least one of a card (for example, a credit card, a cash card, a mobile card, etc.) number, a card expiration date, a check number, a bank account number, and a combination thereof, stored in the first device 100. Also, the paying data may be a value generated by combining the card number, etc. stored in the first device 100, with a random number. Also, the paying data may be a value obtained from the payment server 300. Also, the payment data may be encrypted, for example, by using the session key SSK that is pre-set between the first device 100 and the payment server 300. Also, the first device 100 may transmit the store identification data of the second device 200 to the payment server 300.

In operation S1960, the payment server 300 may transmit the notification that the payment is approved, to the first device 100. The payment server 300 may approve the payment by using at least one of the product data, the paying data and the store identification data received from the first device 100 and may transmit the notification that the payment is approved, to the first device 100. Also, the payment server 300 may transmit the notification that the payment is approved in response to a request of the first device 100, to the second device 200. In this case, the payment server 300 may transmit the notification that the payment is approved, to the second device 200, by using the store identification data of the second device 200.

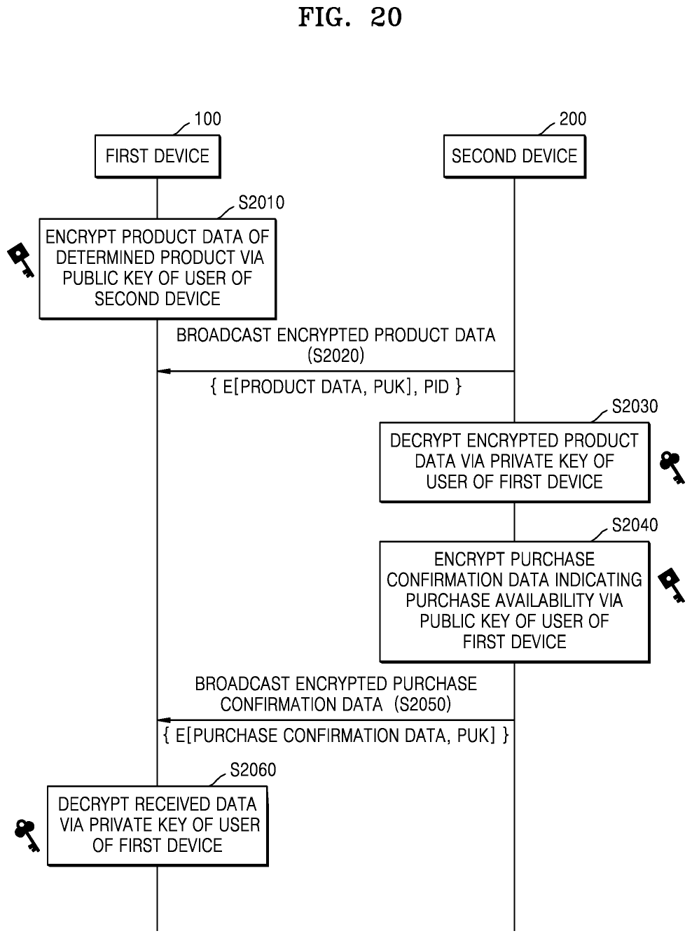

FIG. 20 is a flowchart of a method, performed by the first device 100, of broadcasting the product data of the determined product.

In operation S2010, the first device 100 may encrypt the product data of the determined product by using the public key PUK of the user of the second device 200. The public key PUK of the user of the second device 200 may be obtained from the first device 100 or the authentication server 400.

In operation S2020, the first device 100 may broadcast the encrypted product data. The first device 100 may broadcast the encrypted product data together with the purchaser identification data PID of the first device 100 that is not encrypted. The non-encrypted purchaser identification data PID of the first device 100 may be used for the second device 200 to obtain the public key PUK of the user of the first device 100.

Also, the first device 100 may encrypt the purchaser identification data PID of the first device 100 by using the private key PRK of the user of the first device 100 and broadcast the encrypted purchaser identification data PID. In this case, the encrypted purchaser identification data PID of the first device 100 and the non-encrypted purchaser identification data PID of the first device 100 may be used to authenticate the first device 100.

In operation S2030, the second device 200 may decrypt the encrypted product data by using the private key PRK of the user of the second device 200.

In operation S2040, the second device 200 may encrypt purchase confirmation data indicating a purchase availability of the product to be purchased by the first device 100, by using the public key PUK of the user o the first device 100, based on the product data obtained via the decryption. Also, the purchase confirmation data that is broadcast may further include, for example, order number data for receiving the product, location information of the product, etc.

In some embodiments, when the broadcast product data is obtained from the first device 100, the second device 200 may provide a GUI for receiving a user input about whether or not a purchase of the product is to be confirmed or not, based on the product data. Alternatively, when the second device 200 does not include a display, the second device 200 may provide the obtained product data via another device.

In operation S2050, the second device 200 may broadcast the encrypted purchase confirmation data.

In operation S2060, the first device 100 may decrypt the encrypted purchase confirmation data broadcast from the second device 200, by using the private key PRK of the user of the first device 100. For example, the private key PRK of the user of the first device 100 may be stored in a pre-defined area (for example, a security area) of a memory of the first device 100.

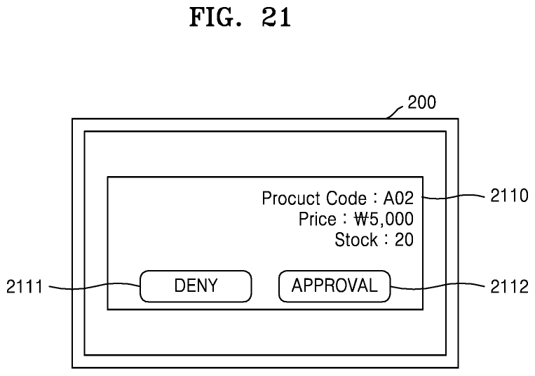

FIG. 21 illustrates an example in which the second device 200 provides a GUI for receiving the purchase confirmation data from a user, as the product data broadcast from the first device is obtained.

Referring to FIG. 21, the second device 200 may provide a GUI 2110 including a product code of the product to be purchased by the first device 100, a price of a product, information about whether there is a product in stock, etc., on a screen of the second device 200, based on the product data broadcast from the first device 100. Also, the GUI 2110 may include a GUI 2111 for broadcasting the purchase confirmation data indicating that a purchase of the product is impossible and a GUI 2112 for broadcasting the purchase confirmation data indicating that a purchase of the product is possible.

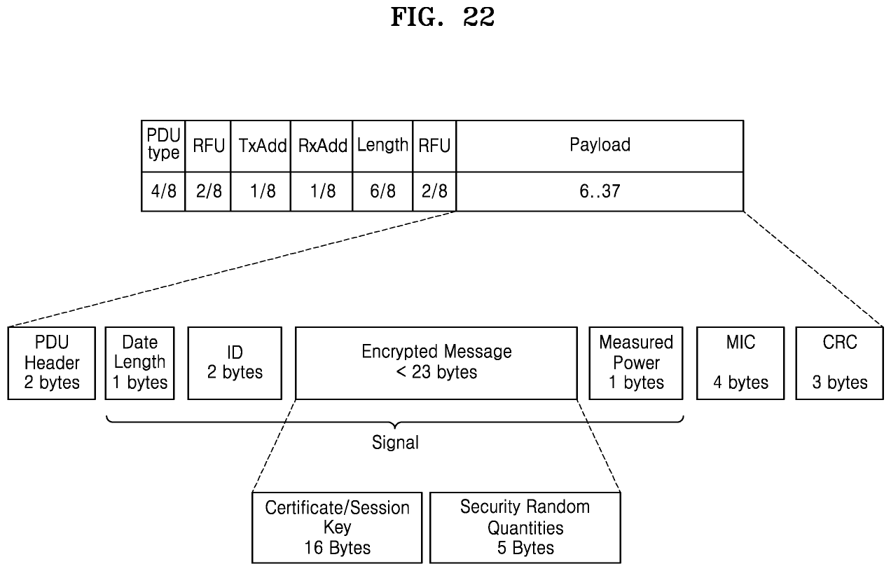

FIG. 22 illustrates a structure of the data that is broadcast in the payment system, according to embodiments.

Referring to FIG. 22, the data broadcast from the first device 100 or the second device 200 according to embodiments may include, for example, a PDU type field, an RFU field, a TxAdd field, an RxAdd field, a length field, an RFU field, and a payload field.

Also, the payload field may include, for example, a PDU header field, a data length field, an ID field, an encrypted messages field, a measured power field, an MIC field, and a CRC field. Also, in the ID field, the purchaser identification data PID of the first device 100 or the store identification data SID of the second device 200 may be recorded. Also, for example, in the encrypted messages field, the encrypted purchaser identification data PID of the first device 100 or the encrypted store identification data SID of the second device 200 may be recorded.

Alternatively, for example, in the encrypted messages field, the encrypted payment data and the encrypted purchase data may be recorded. Alternatively, for example, in the encrypted messages field, the session key and the random number may be recorded. Alternatively, for example, in the encrypted messages field, the store data corresponding to the second device 200 may be recorded.

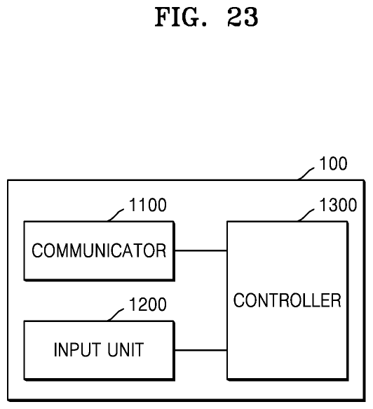

FIGS. 23 through 26 are diagrams for describing operations of the devices included in the payment system according to embodiments. The operations of the devices included in the payment system illustrated in FIGS. 23 through 26 are related to the embodiments described above in FIGS. 1 through 22. Thus, even if omitted, the above descriptions with reference to FIGS. 1 through 22 may be applied to the operations of the devices with reference to FIGS. 23 through 26.

FIGS. 23 and 24 illustrate a structure of the first device 100 according to embodiments.

As illustrated in FIG. 23, the first device 100 according to embodiments may include a communicator 1100, an input unit 1200, and a controller 1300. However, not all illustrated components of FIG. 23 are essential components of the first device 100. The first device 100 may be realized by including more or less components than the components illustrated in FIG. 23.

For example, as illustrated in FIG. 24, the first device 100 according to embodiments may further include a sensor 1400, an output unit 1500, an audio/video (AN) input unit 1600, and a memory 1700, in addition to the communicator 1100, the input unit 1200, and the controller 1300.

The communicator 1100 may include one or more components configured to enable communication with at least one of the second device 200, the payment server 300, and the authentication server 400. For example, the communicator 1100 may include a short-range wireless communicator 1110, a mobile communicator 1120, and a broadcasting receiver 1130.

The short-range wireless communicator 1110 may include, but is not limited to, a Bluetooth communicator, a BLE communicator, a near-field communicator, a WLAN (Wi-Fi) communicator, a Zigbee communicator, an infrared data association (IrDA) communicator, a Wi-Fi direct (WFD) communicator, an ultra wideband (UWB) communicator, an Ant+ communicator, etc.

Also, the short-range wireless communicator 1110 may obtain data that is broadcast within a range of communication. For example, the short-range wireless communicator 1110 may receive the store identification data broadcast from the second device 200. Alternatively, the short-range wireless communicator 1110 may receive the store data broadcast from the second device 200.

The mobile communicator 1120 may transmit and receive a wireless signal to and from at least one of a base station, an external terminal, and a server in a mobile communication network. Here, the wireless signal may include a sound call signal, a video telephony call signal, or data of various forms based on the exchange of a text/multimedia message.

The broadcasting receiver 1130 may receive a broadcasting signal and/or broadcasting-related data from the outside via a broadcasting channel. The broadcasting channel may include a satellite channel and a ground-wave channel. According to embodiments, the first device 100 may not include the broadcasting receiver 1130.

Also, the communicator 1100 may be connected to the payment server 300 and the authentication server 400 and may transmit and receive various information to and from the payment server 300 and the authentication server 400. For example, the communicator 1100 may request the public key PUK of the user of the second device 200 from the authentication server 400 and may receive the public key PUK of the user of the second device 200 from the authentication server 400. Also, the communicator 1100 may transmit the authentication data of the first device 100 to the payment server 300 and may receive a message indicating that the payment is approved from the payment server 300. Also, the communicator 1100 may transmit the payment data to the payment server 300.

The input unit 1200 may refer to a device for receiving data for controlling the first device 100. The input unit 1200 may receive a user input for controlling the first device 100. For example, the input unit 1200 may include a key pad, a dome switch, a touch pad (a touch-capacitance method, a pressure-resistive lay method, an infrared-sensing method, a surface ultrasonic conductive method, a integral tension measuring method, a piezo effect method, etc.), a jog wheel, a jog switch, etc., but is not limited thereto. Also, for example, the input unit 1200 may be an interface for receiving a user input signal from an external input device (not shown).

The controller 1300 may control general operations of the first device 100. The controller 1300 may control other components in the first device 100 to execute the operation of the first device 100. For example, the controller 1300 may generally control the communicator 1100, the input unit 1200, the sensor 1400, the output unit 1500, the AN input unit 1600, etc., by executing programs stored in the memory 1700.

In detail, the controller 1300 may receive the store identification data broadcast from the second device 200, via the communicator 1100. The store identification data may include, for example, at least one of a number, a letter, a figure, and a combination thereof for indicating a store in which the second device 200 is located. The store identification data may be a value assigned from the authentication server 400 and may be unique identification data (for example, a serial number, an MAC address, etc.) of the second device 200. Also, the store identification data may be beacon ID of a beacon device included in the second device 200. Also, the store identification data may be used to authenticate the second device 200.

Also, the controller 1300 may authenticate the second device 200. The store identification data broadcast from the second device 200 may be encrypted by an asymmetric encryption method. For example, the store identification data broadcast from the second device 200 may be encrypted by using the private key PRK of the user of the second device 200. In this case, the controller 1300 may decrypt the store identification data broadcast from the second device 200, by using the public key PUK of the user of the second device 200, and may authenticate the second device 200. The public key PUK of the user of the second device 200 may be obtained via the payment application executed by the controller 1300. For example, the public key PUK of the user of the second device 200 may be obtained from the memory 1700 via the payment application and may be obtained from the authentication server 400. Meanwhile, the payment application may be a program for executing at least one operation for authenticating the second device 200 and purchasing a product sold in a store in which the second device 200 is located by exchanging required information with at least one of the payment server 300 and the authentication server 400 connected to the first device 100 for communication.

Also, the controller 1300 may transmit the store identification data SID decrypted by using the public key PUK of the user of the second device 200 to the authentication server 400, via the communicator 1100. Here, the store identification data Sid decrypted by using the public key PUK of the user of the second device 200 may be encrypted by using the session key that is set between the second device 200 and the authentication server 400.

Also, the controller 1300 may provide a GUI for receiving a user input of determining a product to be purchased.

Also, the controller 1300 may broadcast the payment data of a determined product via the short-range wireless communicator 1110. Here, the payment data may include the product data of the product to be purchased and the paying data for paying a price of the product. The paying data may include at least one of a card (for example, a credit card, a cash card, a mobile card, etc.,) number, a card expiration date, a check number, a bank account number, and a combination thereof, stored in the first device 100. Also, the paying data may be a value generated by combining the card number, etc., stored in the memory 1700, with a random number. Also, the paying data may be a value obtained from the payment server 300.

Also, the controller 1300 may encrypt the payment data by using the public key PUK of the user of the second device 200. The controller 1300 may broadcast the encrypted payment data and the purchaser identification data PID of the first device 100. Alternatively, the controller 1300 may encrypt the payment data by using the symmetric key between the first device 100 and the second device 200. Here, the symmetric key between the first device 100 and the second device 200 may be obtained from the authentication server 400.

The sensor 1400 may sense a state of the first device 100 or a state around the first device 100 and transmit sensed data to the controller 1300.

The sensor 1400 may include, but is not limited to, at least one of a magnetic sensor 1410, an acceleration sensor 1420, a temperature/humidity sensor 1430, an infrared sensor 1440, a gyroscope sensor 1450, a position sensor (for example, a global positioning system (GPS)) 1460, an atmospheric sensor 1470, a proximity sensor 1480, and an RGB sensor (an illuminance sensor) 1490. A function of each of the sensors may be intuitively inferred by one of ordinary skill in the art, and thus, its detailed description will not be given.

The output unit 1500 may output an audio signal, a video signal, or a vibration signal, and may include a display 1510, a sound output unit 1520, and a vibration motor 1530.

The display 1510 may display and output information processed in the first device 100. The display 1510 may display on a screen thereof the GUI provided by the controller 1300. Also, the display 1510 may display an execution screen of an application. For example, the display 1510 may display the execution screen of the payment application, and may display various GUIs provided by the payment application.

Meanwhile, when a layered structure of the display 1510 and the touch pad forms a touch screen, the display 1510 may be used as an input device, in addition to an output device. The display 1510 may include at least one of an LCD, a thin film transistor LCD, an OLED display, a flexible display, a three-dimensional (3D) display, and an electrophoretic display. Also, the first device 100 may include at least two displays 1510, according to an embodiment. Here, the at least two displays 1510 may be arranged to face each other by using a hinge.

The sound output unit 1520 may output audio data received from the communicator 1100 or stored in the memory 1700. Also, the sound output unit 1520 may output a sound signal related to functions (for example, a call signal reception sound, a message reception sound, a notification sound, etc.) performed by the first device 100. The sound output unit 1520 may include a speaker, a buzzer, etc.

The vibration motor 1530 may output a vibration signal. For example, the vibration motor 1530 may output the vibration signal corresponding to an output of audio data or video data (for example, a call signal reception sound, a message reception sound, etc.). Also, the vibration motor 1530 may output the vibration signal when a touch is input on the touch screen.

The A/V input unit 1600 may be used for an input of an audio signal or a video signal, and may include a camera 1610, a microphone 1620, etc. The camera 1610 may obtain an image frame, such as a still image or a video, via an image sensor, in a videotelephony mode or a photographing mode. The image captured by the image sensor may be processed by the controller 1300 or an additional image controller (not shown).

The image frame processed by the camera 1610 may be stored in the memory 1700 or may be transmitted to the outside via the short-range wireless communicator 1100. The camera 1610 may include two or more cameras according to an embodiment of a terminal.

The microphone 1620 may receive an external sound signal and process the external sound signal as electrical sound data. For example, the microphone 1620 may receive the sound signal from an external device or the user. The microphone 1620 may use various noise-removal algorithms to remove noise generated in a process of receiving the external sound signal.

The memory 1700 may store programs for the processing and controlling operations of the controller 1300, and may store data that is input to the first device 100 or output from the first device 100. For example, the memory 1700 may store the purchaser identification data PID of the first device 100, the purchaser identification data PID of the first device 100 being obtained from the authentication server 400, and the private key PRK of the user of the first device 100. Also, the memory 1700 may store the public key PUK of the user of the second device 200, the public key PUK of the user of the second device 200 being obtained from the authentication server 400, and the store data corresponding to the second device 200. Also, the memory 1700 may store a session key, an authentication certificate, etc. used for connection between the payment server 300 and the authentication server 400 for communication.

Also, the memory 1700 may include a certain area (for example, a security area) for limiting an access of other components. The controller 1300 may prevent a program other than authenticated programs from accessing the certain area of the memory 1700. Also, when the authenticated programs access the certain area of the memory 1700, the controller 1300 may require a password for accessing the certain area. Meanwhile, the private key PRK of the user of the first device 100, the public key PUK of the user of the second device 200, the store data corresponding to the second device 200, the session key between the payment server 300 and the authentication server 400, etc., may be stored in the certain area of the memory 1700.

The memory 1700 may include at least one type of storage medium from among a flash memory type, a hard disk type, a multimedia card micro type, a card type memory (for example, SD or XD memory), random-access memory (RAM), static RAM (SRAM), read-only memory (ROM), electrically erasable programmable ROM (EEPROM), programmable ROM (PROM), magnetic memory, magnetic disk, and optical disk.

The programs stored in the memory 1700 may be divided into a plurality of modules based on their functions. For example, the programs may be divided into a user interface (UI) module 1710, a touch screen module 1720, and a notification module 1730.

The UI module 1710 may provide a specialized UI, a GUI, etc., which are synchronized to the electronic device 1000, for each application. The touch screen module 1720 may sense a touch gesture on a touch screen via the user, and transmit information related to the touch gesture to the controller 1300. The touch screen module 1720 according to an embodiment may recognize and analyze a touch code. The touch screen module 1720 may be implemented as additional hardware including a controller.

Various sensors may be provided in or around the touch screen to sense a touch or an approximate touch on the touch screen. An example of the sensor configured to sense the touch on the touch screen may be a haptic sensor. The haptic sensor refers to a sensor configured to sense contact of a specific object to a same degree as human sensitivity or to a higher degree. The haptic sensor may sense various information, such as roughness of a contact surface, rigidity of a contact object, a temperature of a contact point, etc.

Further, another example of the sensor configured to sense the touch on the touch screen may be a proximity sensor. The proximity sensor refers to a sensor configured to sense an object approaching a certain sensed surface, or whether or not an object exists around the certain sensed surface, by using the electromagnetic force or infrared rays, without mechanical contact. The touch and the gesture of the user may include tapping, touching & holding, double tapping, dragging, penning, flicking, dragging and dropping, swiping, etc.

The notification module 1730 may generate a signal to notify about occurrence of an event of the first device 100. Examples of the event occurring in the first device 100 may include reception of a call signal, reception of a message, an input of a key signal, notification of a schedule, etc. The notification module 1730 may output the notification signal as a video signal via the display 1510, output the notification signal as an audio signal via the sound output unit 1520, or output the notification signal as a vibration signal via the vibration motor 1530.

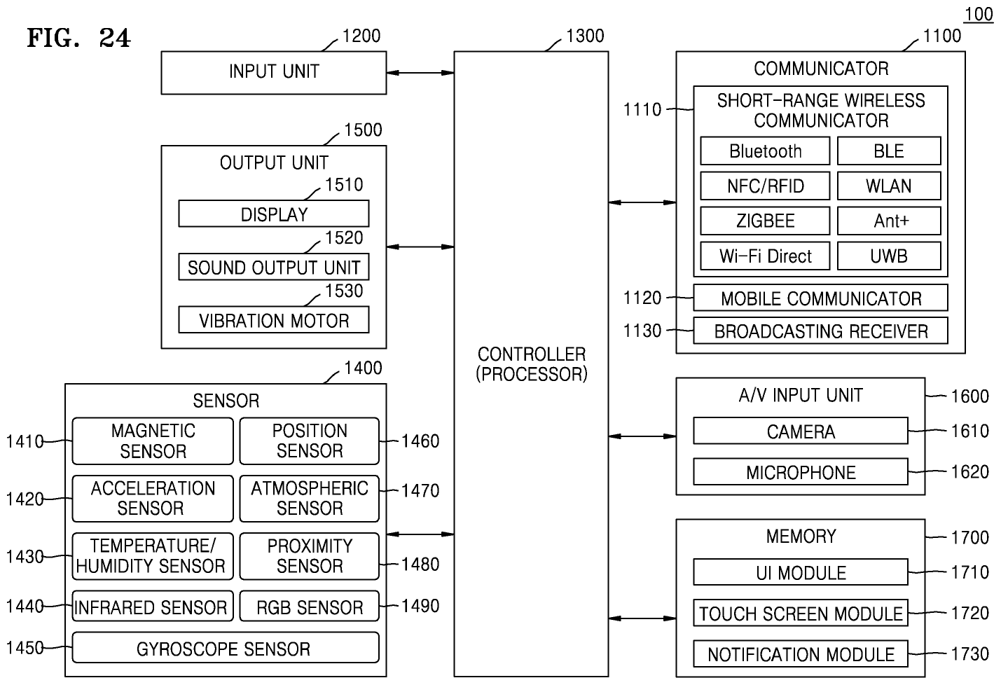

FIG. 25 illustrates a structure of the second device 200 according to embodiments.

Referring to FIG. 25, the second device 200 according to embodiments may include a communicator 2100 and a controller 2300. However, not all illustrated components of FIG. 25 are essential components of the second device 200. The second device 200 may be realized by including more or less components than the components illustrated in FIG. 25. For example, the second device 200 may include the same or substantially the same components as the first device 100 illustrated in FIG. 24.

The communicator 2100 may include one or more components configured to enable communication with at least one of the first device 100, the payment server 300, and the authentication server 400. For example, the communicator 2100 may include a short-range wireless communicator (not shown) and a mobile communicator (not shown).

Also, the communicator 2100 may broadcast the store identification data SID of the second device 200 by encrypting the store identification data SID. For example, the communicator 2100 may broadcast a message including the encrypted store identification data SID and the store identification data SID which is not encrypted. The encrypted store identification data SID and the non-encrypted store identification data SID may be used for the first device 100 to authenticate the second device 200.

Also, the communicator 2100 may broadcast the store data of a store in which the second device 200 is located. The store data may include, for example, a name of a store corresponding to at least one piece of the store identification data SID, product identification data with respect to products sold in a store, price data with respect to products sold in a store, discount coupon data provided by a store, data of events promoted in a store, etc. Alternatively, the store data may include an URL for providing at least one of the pieces of the data described above.

Also, the communicator 2100 may obtain the payment data broadcast from the first device 100 and transmit the obtained payment data to the payment server 300. Also, the communicator 2100 may receive notification that the payment is approved from the payment server 300.

Also, the communicator 2100 may obtain the purchaser identification data PID of the first device 100, the public key PUK of the user of the first device 100, etc., via the authentication server 400.

The controller 2200 may control general operations of the second device 200. The controller 2200 may control other components in the second device 200 to execute the operations of the second device 200 described above. For example, the controller 2200 may generally control the communicator 2100, etc., by executing programs stored in a memory.

In detail, the controller 2200 may receive the payment data broadcast from the first device 100, via the communicator 2100. The payment data may be encrypted by using the public key PUK of the user of the second device 200. The controller 2200 may decrypt the payment data by using the private key PRK of the user of the second device 200. Also, the controller 2200 may provide the payment data to the payment server 300 via the communicator 2100. Also, the controller 2200 may encrypt the payment data provided to the payment server 300 by using the session key that is set between the second device 200 and the payment server 300.

Alternatively, the payment data may be encrypted by using a symmetric key between the second device 20 and the first device 100.

Also, the controller 2200 may generate the purchase confirmation data indicating whether or not a product corresponding to the product data is available to be purchased, based on the product data broadcast from the first device 100, and may broadcast the purchase confirmation data via the communicator 2100.

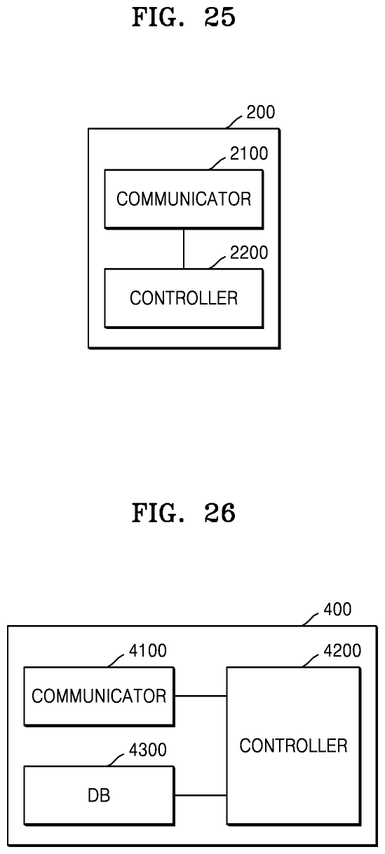

FIG. 26 illustrates a structure of the authentication server 400, according to embodiments.

Referring to FIG. 26, the authentication server 400 according to embodiments may include a communicator 4100, a controller 4200, and a database (DB) 4300. However, not all components illustrated in FIG. 26 are essential components of the authentication server 400. The authentication server 400 may be realized by including more or less components than the components illustrated in FIG. 26.

The communicator 4100 may transmit and receive data to and from the first device 100 or the second device 200. For example, the communicator 4100 may transmit the public key PUK of the user of the first device 100, the public key PUK of the user of the second device 200, the store data corresponding to the second device 200, etc., to the first device 100 or the second device 200.

The controller 4200 may control general operations of the authentication server 400. The controller 4200 may authenticate the second device 200 by controlling the communicator 4100 and the DB 4300.

In detail, the controller 4200 may be connected with the first device 100 or the second device 200 for communication by controlling the communicator 4100. The controller 4200 may be connected with the first device 100 and transmit and receive data to and from the first device 100 based on bi-directional communication, by controlling the communicator 4100. For example, the controller 4200 may be connected with the first device 100 via IP communication, but is not limited thereto.

Also, the controller 4200 may receive a request of authenticating the second device 200, from the first device 100. The controller 4200 may receive the store identification data SID of the second device 200 that is encrypted by using the session key from the first device 100 via the communicator 4100.

Also, the controller 4200 may decrypt the encrypted store identification data SID of the second device 200 that is received from the first device 100, by using the session key that is set between the first device 100 and the authentication server 400. Also, the controller 4200 may decrypt the store identification data SID obtained via the decryption by using the session key that is set between the second device 200 and the authentication server 400.

Also, the controller 4200 may authenticate the second device 200 by using the store identification data SID of the second device 200 that is obtained via the decryption. For example, the controller 4200 may authenticate the second device 200 by comparing the store identification data SID of the second device 200 that is obtained via the decryption with the store identification data SID that is pre-stored in the DB 4300 of the authentication server 400. Also, the controller 4200 may transmit a result of the authentication of the second device 200 to the first device 100 by controlling the communicator 4100.

In the disclosure, it is described that the authentication server 400 and the payment server 300 are separate components. However, the disclosure is not limited thereto. The authentication server 400 and the payment server 300 may perform a function of each other.

The afore-described embodiments may be implemented as an executable program, and may be executed by a general-purpose digital computer that runs the program by using a computer-readable recording medium. Also, a structure of data used in the embodiments may be recorded by using various units on a computer-readable medium. Also, the embodiments may be implemented as a form of a recording medium including a computer-executable instruction, such as a program module executed by a computer. For example, methods implemented as software modules or algorithms may be stored in a computer-readable recording medium as codes or program commands readable and executable by a computer.

The computer-readable medium may be an arbitrary recording medium which can be accessed by a computer, and may include a volatile medium and a non-volatile medium, a separated type and a non-separated type medium. The computer-readable medium may include storage media, such as magnetic storage media, such as read-only memory (ROM), a floppy disk, a hard disk, etc., and optical reading media, such as CD ROM, DVD, etc., but is not limited thereto. Also, the computer-readable medium may include computer storage media and communication media.

Also, the computer-readable recording media can be distributed over network coupled computer systems, and data stored in the distributed recording media, for example, program instructions and codes can be executed by at least one computer.

The particular implementations shown and described herein are illustrative examples of the disclosure and are not intended to otherwise limit the scope of the disclosure in any way. For the sake of brevity, conventional electronics, control systems, software development and other functional aspects of the systems (and components of the individual operating components of the systems) may not be described in detail.

While the disclosure has been particularly shown and described with reference to example embodiments thereof, it will be understood by one of ordinary skill in the art that various changes in form and details may be made therein without departing from the spirit and scope of the disclosure. Hence, it will be understood that the embodiments described above are not limiting of the scope of the disclosure. For example, each component described in a single type may be executed in a distributed manner, and components described distributed may also be executed in an integrated form.

All examples or example terms in the disclosure, for example, the use of the term “etc.” is merely for describing the disclosure in detail, and the scope of the disclosure is not limited by the examples or the example terms. The scope of the disclosure is defined by the scope of the claims.

Also, no item or component is essential to the practice of the disclosure unless the element is specifically described as “essential” or “critical.”

It will be understood by one of ordinary skill in the art that various changes in form and details may be made therein without departing from the spirit and scope of the disclosure.

As the disclosure allows for various changes and numerous embodiments, particular embodiments are not intended to limit the disclosure to particular modes of practice, and it is to be appreciated that all changes, equivalents, and substitutes that do not depart from the spirit and technical scope of the disclosure are encompassed in the disclosure. Thus, the embodiments should be considered in descriptive sense only and not for purposes of limitation.

The scope of the disclosure is defined not by the detailed description of the disclosure but by the appended claims, and all differences and modifications within the scope of the appended claims and equivalents of the claims will be construed as being included in the disclosure.

Also, the terms, such as “unit” or “module,” should be understood as a unit that processes at least one function or operation and that may be embodied in a hardware manner, a software manner, or a combination of the hardware manner and the software manner.

The “unit” and the “module” may be implemented via a program which may be stored in a storage medium which may be addressed and executed by a processor.

For example, the “unit” and the “module” may refer to components, such as software components, object-oriented software components, class components, and task components, and may include processes, functions, attributes, procedures, subroutines, segments of program code, drivers, firmware, micro codes, circuits, data, a database, data structures, tables, arrays, or variables.

In this specification, the description that “A may include one of a1, a2, and a3” may broadly denote that an example which may be included in an element A includes a1, a2, or a3.

The description should not be construed as limited to the meaning that examples which may be included in the element A are necessarily limited to a1, a2, and a3. Thus, it should not be interpreted as excluding other elements than a1, a2, and a3, as examples included in the element A.

Also, the description denotes that the element A may include a1, a2, or a3. The description does not denote that the elements included in the element A are necessarily selected from a certain set of elements. That is, the description should not be restrictively understood as denoting that a1, a2, or a3 necessarily selected from the set including a1, a2, and a3 are included in the element A.

Also, in this specification, the description “at least one of a1, a2, and/or a3” denotes one of “a1,” “a2,” “a3,” “a1 and a2,” “a1 and a3,” “a2 and a3,” and “a1, a2, and a3.”

Thus, it should be noted that unless explicitly described as “at least one of a1, at least one of a2, and/or at least one of a3,” the description “at least one of a1, a2, and/or a3” is not interpreted as “at least one of a1,” “at least one of a2,” and/or “at least one of a3.”

1. A method, performed by a first device, of purchasing a product, the method comprising:
receiving store identification data broadcast from a second device, when the first device is located within a range of short-range communication with respect to the second device;
authenticating the second device by using the store identification data;
receiving a user input of determining a product to be purchased, when a user of the second device is authenticated; and
broadcasting payment data for purchasing the determined product via the short-range communication,
wherein the broadcast payment data is provided to the second device.

2. The method of claim 1, wherein the store identification data is encrypted using a private key of the user of the second device.

3. The method of claim 2, wherein the authenticating of the second device comprises decrypting the encrypted store identification data by using a public key of the user of the second device, and
the public key is provided to the first device via a payment application installed in the first device.

4. The method of claim 3, wherein the public key of the user of the second device is stored in the first device or an external server.

5. The method of claim 1, wherein the payment data comprises paying data obtained from a payment server when the user input is received, and
the paying data is temporarily generated by using a random number and a card number of a user of the first device, the card number being registered in the payment server.

6. The method of claim 1, wherein the broadcasting of the payment data comprises:
encrypting product data of the determined product and the payment data by using a public key of the user of the second device; and
broadcasting the encrypted product data and the encrypted payment data.

7. The method of claim 1, further comprising obtaining a list of products sold at a store in which the second device is installed,
wherein the determining of the product to be purchased comprises determining the product to be purchased based on the obtained list of the products.

8. The method of claim 7, wherein the list of the products is broadcast from the second device.

9. The method of claim 1, wherein the first device communicates with the second device via Bluetooth low energy (BLE).

10. The method of claim 1, wherein the store identification data and the payment data are broadcast between the first device and the second device, and the first device and the second device are not in connection with each other for communication.

11. A method, performed by a first device, of purchasing a product, the method comprising:
receiving store identification data broadcast from a second device, when the first device is located within a range of short-range communication with respect to the second device;
authenticating the second device by using the store identification data;
receiving a user input of determining a product to be purchased, when a user of the second device is authenticated;
broadcasting product data of the determined product; and
transmitting payment data for purchasing the determined product to a payment server,
wherein the product data is provided to the second device.

12. The method of claim 11, wherein the broadcasting of the product data comprises:
encrypting the product data by using a public key of the user of the second device; and
broadcasting the encrypted product data.

13. A first device comprising:
a communicator configured to receive store identification data broadcast from a second device, when the first device is located within a range of short-range communication with respect to the second device;
a controller configured to authenticate the second device by using the store identification data; and
an input unit configured to receive a user input of determining a product to be purchased, when a user of the second device is authenticated,
wherein the communicator is further configured to broadcast payment data for purchasing the determined product via the short-range communication, and
the broadcast payment data is provided to the second device.

14. The first device of claim 13, wherein the store identification data is encrypted using a private key of the user of the second device.

15. A computer-readable recording medium having recorded thereon a program for executing the method of claim 1.
